(19) United States
(12) Patent Application Publication
(10) Pub. No.: US 2020/0255629 A1
(43) Pub. Date: Aug. 13, 2020

(54) MANUFACTURING METHOD AND PRODUCTS

(71) Applicant: NEWSOUTH INNOVATIONS PTY LTD, Sydney, New South Wales (AU)

(72) Inventors: VEENA H. SAHAJWALLA, Sydney, New South Wales (AU); VAIBHAV GAIKWAD, Sydney, New South Wales (AU); FARSHID PAHLEVANI, Sydney, New South Wales (AU); CLAUDIA ALEJANDRA ECHEVERRIA ENCINA, Sydney, New South Wales (AU); HERIYANTO HERYANTO, Sydney, New South Wales (AU)

(21) Appl. No.: 16/608,636

(22) PCT Filed: Apr. 27, 2018
(86) PCT No.: PCT/AU2018/050390

§ 371 Date: Oct. 25, 2019

(30) Foreign Application Priority Data
Apr. 27, 2017 (AU) 2017901528
Apr. 27, 2017 (AU) 2017901529

(51) Int. Cl. C08K 11/00; B29C 43/00; C08K 3/40

(52) U.S. Cl. CPC C08K 11/005; B29K 2023/12; C08K 3/40; B29C 43/003

(57) ABSTRACT

This disclosure relates to a method of utilising waste products in manufacturing. It is particularly suited to manufacturing composite products for applications including, but not limited to, structural, thermal insulation, acoustic insulation and related applications and is described in relation to manufacture in small scale environments but it will be clear that the method and products have broad applications.

### TECHNICAL FIELD

This disclosure relates to a method of utilising waste product in manufacturing. It is particularly suited to manufacturing of engineered composites for applications including structural, thermal insulation, acoustic insulation and related applications and is described in relation to manufacture in small scale environments but it will be clear that the method and products have broad applications.

### BACKGROUND OF THE DISCLOSURE

In the formation of recycled product, the varied quality, density, melting point, and other processing factors of varied waste materials means that high cost technology and/or complex equipment is often required to satisfactorily clean or segregate waste materials for recycling. This is particularly significant in the recycling of treated timber and engineered wood products and the recycling of glass and complex glass products. The result is significant costs in recycling and an inability to utilise a substantial portion of wood and glass waste in recycling.

In terms of structural products from wood wastes, eco-particleboards made from recycled waste wood as well as agro-waste by-products are available. These include:
Recycled wood particleboards using recycled wood packaging and manufacturing offcuts in the manufacture of new particleboards consisting of approx. 83% total recycled material, 74% post-industrial material from other sawmills waste, sawdust, wood chip and residues, and 9% post-consumer recycled wood waste chip material.
Recycled agro-waste particleboard based on annually renewable waste resources such as rice straw and banana tree trunks. Similarly, the waste trunk of the banana palm is converted into alternatives to forest wood products, after harvesting the fruit. This raw material is used by the paper, packaging, furniture, building, construction and other industries.
Experimental agro-wastes and forestry by-products sustainable particleboards based on Australian agricultural and forestry by-products, natural materials such as Macadamia shells, Radiata pine cones and Eucalyptus capsules, these materials being bonded with non-toxic, renewable or recycled castor oil-based polyurethane and recycled polypropylene.
Wood-plastic composite particleboards made from wood wastes, in the form of wood flour or sawdust have evolved into a new generation of wood-plastic composites (WPCs). WPCs are composite materials made of wood fibre/wood flour as a filler in combination with thermoset or thermoplastic polymer as a binder or matrix. The incorporation of water repellent plastics encapsulating the wood particles reduces the hygroscopicity of the composite, extending its lifespan. The advantages of WPC are good stiffness and impact resistance, excellent thermal properties, dimensional stability due to low water absorption and resistance from fungal or insect attack. The main disadvantage of WPC is that natural fibres are incompatible with the hydrophobic polymer matrix and have a tendency to form aggregates, which affect the quality interface of fibre-matrix. Hydrophilic natural fibres exhibit poor resistance to moisture and humid environments. In an attempt to eliminate these problems, physical and chemical methods can be used to optimize natural fibre interface.

A further disadvantage of standard particleboards is the use of urea formaldehyde as a main binder. This is problematic as particleboards are mostly used for interior panelling and furniture applications. If toxic fumes are released from the particle board it affects the overall indoor air quality of buildings over time.

Recycled glass from glass waste is also known, however glass is separated for this process to maintain a consistent melting temperature and strength, and to reduce flaws in the recycled glass.

It is to be understood that a reference to the background and prior art does not constitute an admission that the background and prior art forms a part of the common general knowledge in the art, in Australia or any other country.

### SUMMARY OF THE DISCLOSURE

Disclosed is a method of manufacturing a composite product comprising: providing particles of unseparated waste material including at least a binding portion of a polymer waste material; mixing the waste material to provide a quantity of waste material with a generally consistent composition across the material; and applying heat and pressure to the quantity of waste material to form a composite product.

In some forms, at least a portion of the polymer waste material is polypropylene.

In some forms, the binding portion of polymer waste material comprises at least 30% w/w of the quantity of waste material.

In some forms, the unseparated waste material includes wood waste. In some forms, the wood waste comprises at least about 50% w/w of the quantity of waste material. In some forms, the wood waste comprises wood product from a variety of tree species.

In some forms, the unseparated waste material includes glass waste. In some forms the glass waste comprises at least about 50% w/w of the quantity of waste material. In some forms, the glass waste comprises mixed glass or complex glass products.

In some forms, the unseparated waste material includes metal or metallic oxide waste.

In some forms, the unseparated waste material includes paper. The paper may be attached to glass waste, for example, as part of a packaging label.

In some forms, the method further comprises mixing the waste material with a coupling agent such as a silane coupling agent.

In some forms, the method further comprises mixing the waste material with a pigment.

In some forms, the composite product is a panel.

In some forms, there is provided a method of manufacturing a composite product comprising: providing particles of unseparated waste material including at least a portion of a polymer waste and a portion of glass waste; mixing the waste material to provide a quantity of waste material with a generally consistent composition across the material; and applying heat and pressure to the quantity of waste material to form a composite product.

In some forms, there is provided a method of manufacturing a composite product comprising: providing particles of unseparated waste material including at least a portion of a polypropylene waste; mixing the waste material to provide a quantity of waste material with a generally consistent composition across the material; and applying heat and pressure to the quantity of waste material to form a composite product.

In some forms, there is provided a method of manufacturing a composite product comprising: providing particles of unseparated waste material including at least a portion of a polypropylene waste and a portion of glass waste; mixing the waste material to provide a quantity of waste material with a generally consistent composition across the material; and applying heat and pressure to the quantity of waste material to form a composite product.

In some forms, there is provided a method of manufacturing a composite product comprising: providing particles of unseparated waste material including at least a portion of a polymer waste and a portion of glass waste; mixing the waste material to provide a quantity of waste material with a generally consistent composition across the material, wherein the glass waste comprises at least about 50% w/w of the quantity of waste material; and applying heat and pressure to the quantity of waste material to form a composite product.

In some forms, there is provided a method of manufacturing a composite product comprising: providing particles of unseparated waste material including at least a portion of a polypropylene waste and a portion of glass waste; mixing the waste material to provide a quantity of waste material with a generally consistent composition across the material, wherein the glass waste comprises at least about 50% w/w of the quantity of waste material; and applying heat and pressure to the quantity of waste material to form a composite product.

In some forms, there is provided a method of manufacturing a composite product comprising: providing particles of unseparated waste material including at least a portion of a polymer waste and a portion of glass waste; mixing the waste material to provide a quantity of waste material with a generally consistent composition across the material, wherein the glass waste comprises at least about 50% w/w of the quantity of waste material and the polymer waste comprises at least about 30% w/w of the quantity of waste material; and applying heat and pressure to the quantity of waste material to form a composite product. In an embodiment of this form the polymer waste may be polypropylene waste.

Also disclosed is a composite product manufactured by the methods described above.

Further disclosed is a composite product comprising unseparated waste material wherein the unseparated waste material comprises a binding polymer and glass.

In some forms, the binding polymer comprises at least about 30% w/w of the unseparated waste material.

In some forms, at least a portion of the binding polymer is polypropylene.

In some forms, the glass comprises at least about 50% w/w of the unseparated waste material.

In some forms, the composite product further comprises a coupling agent.

In some forms, the composite product is a panel.

In some forms, the composite product comprises wood, paper, e-waste, stone particles, concrete, textile, seaweed or seashell.

The methods in some forms have the benefit of modifying waste materials (eg, wood, glass, plastic, textile and marine waste such as seaweed and seashell) into resources for the development of engineered wood-plastic, bio-composite or glass-based composite for building, furniture and architectural applications.

Waste plastics, complex glass, such as laminated windscreens, textiles, pallets, particleboard and cardboard, and food industry waste such as oyster shells and agricultural waste, can in some forms produce high quality waste-based products. These include engineered stone and tiles—for use in kitchens, for example—as well as boards and panels suitable for interior fit outs and furniture.

In some forms, the methods can be utilised to make pellets for use as feedstock in, for example, the iron and steel industries. In this form the metal or metal oxides may be bound by polymer. In some forms, the polymer is broken down to act as a carbon binder to bind the material.

In some forms, the disclosure allows a user to work efficiently with mixed wood waste from different sources.

In some forms, timber is cleaned via selective thermal transformation.

In some forms, the process minimizes transportation costs by capturing and/or processing wood waste materials closer to the initial source of waste generation. The disclosed methods and systems can easily be set up close to the manufacturing company for treating waste locally.

In some forms, recycled polypropylene acts as a binder. In some forms, this has the benefit of further reducing or replacing the use of urea formaldehyde (UF).

In some forms, using recycled materials instead of virgin materials for glass production will demand fewer non-renewable resources from the ground and cause less waste to be buried in landfills.

In some forms, the methods described herein comprise steps that are carried out at high temperatures, but these steps may be deployed in small scale micro-factories or mobile micro-factory units.

In some forms, applying pressure and heat (hot-pressing) has the benefit of being cost effective and usable in a small scale operation.

Recovered material from local post-consumer as well as end-of-life woods or glass may be selected as the main raw materials and waste plastics or waste textile as binder. In some forms, macro algae and mollusc wastes may be selected as secondary fillers in wood-plastic bio-composite to enhance performance in certain applications.

In some forms, greater resource recovery rates at the end-of-life of a product or a building may be achieved if wood elements are specifically designed for disassembly and classification at the end of their service. In the disclosure, wood-plastic bio-composite waste materials (wood, plastic and marine waste such as seaweed and seashell) have been used which is completely recyclable and can be reused for producing wood-plastic bio-composite at the end of its life.

This bio-composite is designed for a consistent state of non-toxicity for end users, regarding chemical and biological VOCs (e.g. mould) for the whole product's lifespan.

### BRIEF DESCRIPTION OF THE DRAWINGS

Non-limiting embodiments will now be described, by way of example only, with reference to the accompanying drawings.

FIG. 1 shows a perspective view of a composite product of one embodiment of the disclosure.

FIG. 2 shows a perspective view of a composite product of a second embodiment of the disclosure in use.

FIG. 3 shows (A) SEM and (B) X-ray diffraction analysis of glass powder.

FIG. 4 shows yellowing effect of (A) general epoxy and (B) UV resistant epoxy.

FIG. 5 shows interface modification of glass powder and resin with the optimum amount of silane coupling agent.

FIG. 6 shows (A) compression and tension region under compression load, and (B) thin narrow area suitable for fibre mesh reinforcement.

FIG. 7 shows a method of manufacturing a polymeric glass composite panel from an unseparated waste material comprising glass waste.

FIG. 8 shows schematic of (A) wear resistant test (B) scratch resistant test.

FIG. 9 shows cross-section of PGC showing zero air bubble in 75-85% glass powdered concentration.

FIG. 10 shows schematic of glass powder-resin interaction under compression load at resin percentage (A) smaller than 25% and (B) larger than 25%.

FIG. 11 shows flexural strength (MOR) and modulus of elasticity (MOE) of PGC with varying composition and silane coupling agent.

FIG. 12 shows (A) delamination of glass bead of PGC without coupling agent, and (B) interface modification of glass powder and resin with 2% silane coupling agent.

FIG. 13 shows relatively weak chemical bonding between glass powder and resin due to excessive amounts of coupling agent.

FIG. 14 shows compressive strength of PGC with varying compositions and with/without silane coupling agent.

FIG. 15 shows comparison of mechanical properties of PGCs with the natural and engineering stone.

FIG. 16 shows penetration depth of tested samples.

FIG. 17 shows wear profile of tested samples (A-E); (F) correlation of wear resistant with hardness.

FIG. 18 shows particle size distribution in (A) engineering stone (B) PGC.

FIG. 19 shows comparison of water absorption of uncoated PGCs with the natural and engineering stone.

FIG. 20 shows delamination of polyurethane coat in PGCs.

FIG. 21 shows thermal degradation of artificial stone and resin.

FIG. 22 shows scorch test of PGC at 8 different temperatures (Unit: Celsius).

FIG. 23 shows (A-C) PGC with colour pigment added.

FIG. 24 shows interface modification of inorganic powder with silane coupling agent.

FIG. 25 shows a schematic procedure relating to a powder-resin composite panel.

FIG. 26 shows (A) flexural strength of polymeric glass composite (PGC) panel with different types of pigment, and (B) fracture surface of PGC with (1) liquid pigment (2) powder pigment.

FIG. 27 shows (A) solid coloured panel from different waste filler, and (B) marble like panel from combined waste filler and pigment.

FIG. 28 shows flexural strength of powder-resin composite with varying powder filler and silane coupling agent.

FIG. 29 shows SEM analysis of powder filler morphology.

FIG. 30 (A) SEM analysis of glass substrate (i) before (ii) after silane treatment, and contact angle of resin on (B) silica & (C) CaCO₃ based substrate (i) before (ii) after silane treatment.

FIG. 31 shows SEM analysis of powder-resin composite panel (A) before & (B) after silane treatment.

FIG. 32 shows percent improvement of powder-resin composite with varying powder filler after silane CA treatment.

FIG. 33 shows (A) flexural testing graph on polymeric glass composite panel, and (B) shear lip and toughness of powder-resin composite panel.

FIG. 34 shows shear lip of powder-resin composite (A) before (B) after treatment, and (C) fracture surface schematic of powder resin composite.

FIG. 35 shows compressive strength of powder-resin composite panel with varying powder filler and silane coupling agent.

FIG. 36 shows penetration depth of powder-resin composite with varying powder filler.

FIG. 37 shows XRD analysis of (A) pure CaCO₃ (B) sea shell.

FIG. 38 shows water absorption of powder-resin composite with varying powder filler, and addition of coupling agent and sealant.

FIG. 39 shows contact angle of water on powder-resin composite (A) before (B) after silane treatment.

FIG. 40 shows thermal degradation of powder-resin composite with varying powder filler.

FIG. 41 shows panels.

FIG. 42 shows surface characteristics of glass (i) aggregate (ii) powder.

FIG. 43 shows (A) yellowing effect of marine and general epoxy resin, and (B) thermal degradation of marine-based epoxy.

FIG. 44 shows gap graded composite system.

FIG. 45 shows an experimental procedure relating to PGAC.

FIG. 46 shows glass resin composites.

FIG. 47 shows flexural strength (MOR) and modulus of elasticity (MOE) of PGAC with varying aggregate sizes and silane coupling agent.

FIG. 48 shows surface modification of glass by silane coupling agent.

FIG. 49 shows (A) glass aggregate (i) before (ii) after silane treatment; (B) SEM analysis of glass surface (i) before (ii) after silane treatment; (C) contact angle of resin on glass surface (i) after (ii) before silane treatment.

FIG. 50 shows (A&B) SEM analysis of the composite panels (i) without and (ii) with silane treatment, and (C) cross-section of the PGAC fracture surface panel (i) without and (ii) with silane treatment.

FIG. 51 shows compression stress of PGAC with varying aggregate sizes and silane coupling agent.

FIG. 52 shows water absorption of PGAC with varying aggregate sizes and silane coupling agent.

FIG. 53 shows contact angle of water on powder-resin composite (i) before (ii) after silane treatment.

FIG. 54 shows scratch test of resin, glass and powder resin matrix compared with reference samples.

### DETAILED DESCRIPTION

Disclosed is a method of manufacturing a product, the method comprising providing unseparated waste material such as, for example, mixed wood waste, plastic waste, glass waste, complex glass, marine waste or a combination of wastes. The waste ideally comprises a combination of structural or fill material such as, for example, fibrous material and mineral material, along with a binding material such as a polymer material.

In some forms, disclosed is a method of manufacturing a composite product comprising: providing particles of unseparated waste material including at least a binding portion of a polymer waste material; mixing the waste material to provide a quantity of waste material with a generally consistent composition across the material; and applying heat and pressure to the quantity of waste material to form a composite product.

In some forms, the heat applied is between about 150 and about 280 degrees C. In some forms, the heat applied is between about 170 and about 260 degrees C. In some forms, that temperature is about 190 degrees C.

In other forms, the heat applied is between about 70 degrees C. and about 100 degrees C., or between about 70 degrees C. and about 90 degrees C.

In some forms, the pressure applied is between about 50 bar and about 1,000 bar such as between about 50 bar and 750 bar or between about 50 bar and 650 bar, or preferably, between about 50 bar and 500 bar. In some forms, the pressure applied is about 200 bar or about 220 bar.

In some forms, at least a portion of the polymer waste material is polypropylene. Other suitable polymers may include, for example, thermoplastic polymers, acrylonitrile butadiene styrene, polylactic acid, styrene acrylonitrile, polypropylene, polyethylene, high density polyethylene, low density polyethylene, linear low density polyethylene, ultra high molecular weight polyethylene, polyvinyl chloride, polyethylene terephthalate, nylon, polysteyrene, high impact polystyrene, polyoxymethylene (acetal), poly(methyl methacrylate), polyester or polycarbonate.

In some forms, the binding portion of polymer waste material comprises at least 10% w/w of the quantity of waste material, such as at least about 15% or at least about 20% or at least about 25% or at least about 30% or at least about 35% or at least about 40% or at least about 45% or at least about 50% or at least about 55% or at least about 60% w/w of the quantity of waste material. In a preferred embodiment, the binding portion of polymer waste material comprises at least 30% w/w of the quantity of waste material.

In some forms, the unseparated waste material includes wood waste. The wood waste may comprise at least about 20% of the quantity of waste material, such as at least about 25% or at least about 30% or at least about 35% or at least about 40% or at least about 45% or at least about 50% or at least about 55% or at least about 60% or at least about 65% or at least about 70% of the quantity of waste material. In a preferred embodiment, the wood waste material comprises at least about 50% of the quantity of waste material.

Wood waste, such as timber waste, may be cleaned via selective thermal transformation, which allows the transformation of treated wood into carbons at high temperatures. Certain treatments can complicate the processing of woods due to the presence of materials such as chromated copper arsenate (CCA). By conducting selective thermal transformation at high temperatures, the original molecular structures are transformed into different structures comprising carbon which may be used according to the methods described herein.

In some forms, the unseparated waste material includes glass waste. The glass waste may comprise at least about 20% of the quantity of waste material, such as at least about 25% or at least about 30% or at least about 35% or at least about 40% or at least about 45% or at least about 50% or at least about 55% or at least about 60% or at least about 65% or at least about 70% of the quantity of waste material. In a preferred embodiment, the glass waste material comprises at least about 50% of the quantity of waste material.

Further disclosed is a composite product manufactured by the methods described herein.

Conventional recycling processes often require arduous sorting, collection and transport of waste, as well as expensive large scale industrial infrastructure, and mostly merely turn waste back into more of the same, glass back into more glass. The disclosed embodiments in some forms take complex materials and mixes of waste, without the need for sorting. This reduces the waste that is rapidly piling up in landfills because it cannot be easily and cost-effectively recycled.

The rate of wood recovery in recycling is limited by several factors. A large portion of wood waste is legally inhibited from returning into industry as recycled materials due to chemical treatment, coating or cross-contamination which affects the cost-effectiveness of the recovery routes. Moreover, seasonal sources of timber, mixed timber species and waste stream origin affect traditional wood panels' performance and properties. For an effective reutilization of timbers they ordinarily come from the same tree species or similar ones. The recovery rate of useful wood waste material is also limited by cross-contamination with other materials, particularly in the mixed waste stream.

Glass comes from three main raw materials: silica sand, limestone and soda ash. In Australia, the manufacture of glass, however, does not usually use 100% of these raw materials. Some percentage of waste glass is recycled and mixed in the glass production process. Glass can be continually recycled over a million times to produce bottles and other glass products generally with the same quality every time. However, not all waste glass can be recycled into new glass because of impurities, expensive shipping costs, mixed colour waste streams and additives that are difficult to separate into useful raw glass cullet. Use of this waste glass for construction materials is an attractive option because of the volume of material involved, the capacity for use of the material in bulk, and the likely ability of construction applications to afford allowances for slight variation in composition or form.

In shops, damaged processed glass sheets and sheet glass cuttings usually go to waste, and are not typically recycled at present, instead being delivered to landfills. Using glass powder in concrete provides interesting economic outcomes in relation to waste disposal sites. In concrete, glass powder is often used as a partial replacement for natural sand and may provide beneficial pozzolonic reaction in the concrete, replacing up 30% of cement.

The methods described herein may be used to produce composite products such as structural supports or insulation panels, or other shaped objects.

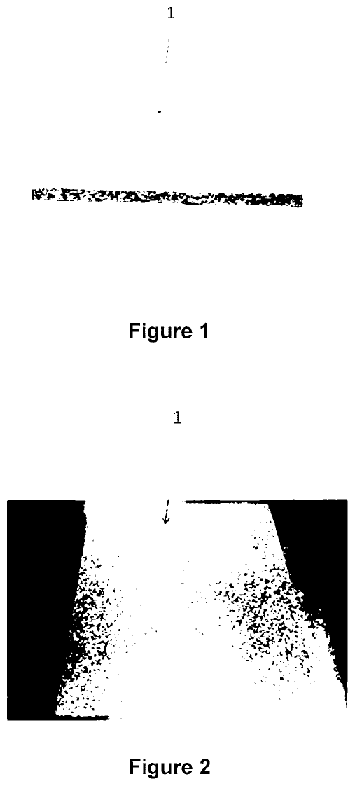

As shown in FIGS. 1 and 2, the procedure is utilised in some forms to produce panels. The panels 1 are generally flat in appearance and configuration although any shape of product falls within the scope of the application. The panels may act as structural or insulation, or as audio panels.

In some forms, the process comprises providing waste material sourced, for example, at a landfill. The waste material is reduced in particle size such that it has a suitable size for forming a structural product. In some forms, this size is between about 20 microns and about 500 microns such as between about 50 microns and 400 microns or between about 100 microns and 300 microns. Preferably, the particle size is less than about 400 microns, such as less than about 300 microns, or less than 200 microns or less than 100 microns. The step of reducing the particle size may comprise cutting or chopping the material into pieces, and crushing or grinding the product using, for example, a mill or crusher or other size reduction steps. The waste material is then mixed such that the composition throughout the quantity of waste material is substantially consistent in terms of material present.

Heat and pressure are then applied to the mixed waste material simultaneously. For example, the waste material can be loaded into a die and hot pressed within the die. In some forms, the die is generally rectangular or square. Hot pressing of the quantity of waste material within the die produces a product that can be utilised, for example, in a structural, architectural or furniture assembly.

In some forms, the mixed waste material is extruded into a pellet or other form. In some forms, the pellets comprise metal or metal oxide pellet material and are greater than 10 mm in diameter.

The binder used may be in the form of a plastic such as polypropylene, polyethylene or other plastic polymers. Other suitable polymers may include, for example, thermoplastic polymers, acrylonitrile butadiene styrene, polylactic acid, styrene acrylonitrile, high density polyethylene, low density polyethylene, linear low density polyethylene, ultra high molecular weight polyethylene, polyvinyl chloride, polyethylene terephthalate, nylon, polysteyrene, high impact polystyrene, polyoxymethylene (acetal), poly(methyl methacrylate), polyester or polycarbonate. The structural material may comprise wood waste that is unsorted and, in some forms, combines more than one type of wood. In producing the quantity of waste material, a manufacturer should consider the type and quantity of binder. The ratio of structural product such as wood or glass waste to binder should also be considered. The temperature, pressure and time of hot setting may affect the properties of the product produced.

In some forms, the ratio of structural material to binder is about 50:50, or in other forms, about 60:40. In some forms, that ratio is about 70:30 or about 75:25. In some forms, the temperature applied to the waste material in the die is between about 150 and 280 degrees C., or between about 150 and 220 degrees C. In some forms, that temperature is about 190 degrees C. In some forms, the pressure applied to the waste material in the die is about 50 bar to about 1,000 bar, or between about 50 bar and about 300 bar. In some forms, that pressure is higher for production of large panels and lower for production of small panels. In some forms, the pressure is about 210 bar for large panels and about 70 bar for small panels. In some forms, the time heat and pressure are applied is between about 15 minutes and about 60 minutes. In some forms the time the structure is under press is longer for large panels and shorter for small panels.

In the disclosed methods, controlled high temperature reactions selectively break and reform the bonds between different elements within the waste mix.

In some forms, other waste material such as marine waste is used. Mechanical, acoustic, moisture absorption and thermal properties of macro algae and mollusc wastes present great properties as novel reinforcement or filler for hybrid as well as polymeric composite mixtures for building as well as for interior architectural applications.

In some forms, the method comprises obtaining raw materials such as wood waste and polymer waste. The wood waste may be mixed and come from a variety of sources. The polymer material may be ground or crushed to reduce its size and the wood may be reduced in size as necessary. The wood waste and polymer waste may be mixed to obtain a relatively consistent composition throughout the waste material. The material may then be loaded into a die and hot pressed.

In some forms, the process comprises obtaining raw material such as waste window glass, stone aggregates, sea shells, decorative stone or a combination thereof. The waste window glass may be crushed by a ring mill into a fine powder. The stones and seashells may be crushed by a jaw crusher into a powder. The resultant particle size may be between 100 and 300 microns in some forms. The powdered waste material may then be combined with a resin, catalyst, UV inhibitor or fire retardant as desired and mixed to form a clay-like substance. The mixture may then be positioned in a mould and agitated in order to remove air from the mixture. The mixture may then be pressed and cured for about 3 hours or more to ensure solidification.

In some forms, sea shell or other material is incorporated into the composite product. In some forms, wollastonite or other compounds are utilised in the process. In some forms, the wollastonite decreases shrinkage and gas evolution, increases green and fired strength, and reduces cracking and defects.

The polymeric glass composite panels may be used as benchtops for kitchens and bathrooms. Their look and feel may be such that they are virtually indistinguishable from stone benchtops, yet cost less to produce.

Also encompassed by the present invention is a composite product comprising a mixture of waste products that may include wood waste product, glass waste product, marine waste product or polymer waste product hot pressed into a structural product.

In the detailed description, reference is made to accompanying drawings which form a part of the detailed description. The illustrative embodiments described in the detailed description and depicted in the drawings are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

The term “about” is understood to refer to a range of +/−10%, preferably +/−5% or +/−1% or, more preferably, +/−0.1%.

### Example 1

### Waste Glass Powder

For this example, waste window glass, tempered glass, laminated glass and borosilicate glass were mixed to replicate the diverse glass waste stream. The chemical composition of the various glasses was analysed by using X-Ray Fluorescence (XRF), as shown in Table 1. All the glass types, except borosilicate glass, contained mostly SiO₂, Na₂O, CaO, with a small proportion of Al₂O₃ and MgO. Borosilicate glass has a slightly higher percentage of SiO₂ and contains B₂O₃ rather than CaO. Unlike Quartz powder which was made from crystalline silica, the SiO₂ in the waste glass is amorphous as shown by X-ray diffraction (XRD) analysis. Although amorphous SiO₂ does not offer extraordinary properties as crystalline SiO₂ in Quartz, amorphous SiO₂ retains its general characteristics of low thermal expansion, high melting point, medium hardness and good abrasion resistance. It deserves consideration as raw materials replacement of Quartz powder in countertop production.

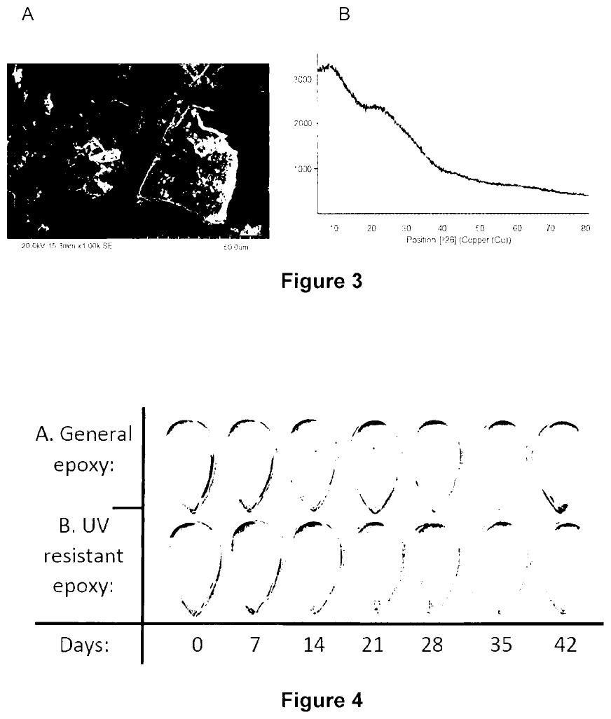

Scanning Electron Microscope (SEM) analysis in FIG. 3 also showed that glass powder has compact irregular oblong shape particles. These angular surface topography leads to an increase in cohesion (the ability of the glass powder to stick together) and internal friction angle (grain-grain friction resistant). These factors might decrease workability as the glass powder tend to clump together. Vigorous mixing may therefore be helpful. On the contrary, having filler with high friction angles may induce high shear yielding in the final product which results in higher strength. The glass powder could, therefore, be a valuable filler in countertop slab production.

TABLE 1
XRF elemental analysis of different types of glasses in weight percentage (wt %).

| Waste | | | | | | | | |
|---|---|---|---|---|---|---|---|---|
| glasses | SiO₂ | Al₂O₃ | MgO | CaO | Na₂O | Fe₂O₃ | B₂O₃ | Others |
| Window | 71.216% | 1.087% | 3.628% | 8.931% | 14.387% | 0.174% | 0.000% | 0.577% |
| (float glass) | | | | | | | | |
| Laminated | 71.596% | 0.051% | 4.090% | 9.273% | 13.955% | 0.082% | 0.000% | 0.953% |
| glass | | | | | | | | |
| Borosilicate | 75.626% | 2.258% | 0.026% | 0.013% | 4.590% | 0.006% | 15.640% | 1.841% |
| glass | | | | | | | | |
| Tempered | 72.187% | 0.067% | 4.095% | 9.377% | 13.875% | 0.116% | 0.000% | 0.283% |
| glass | | | | | | | | |
| Mixed glass | 72.656% | 0.8658% | 2.959% | 6.899% | 11.702% | 0.0945% | 3.910% | 0.9135% |

### Binder

The resin used in this example was modified epoxy casting resin with characteristics of medium viscosity, non-toxic, good chemical and abrasion resistance and high UV resistance. The resin was mixed at hardener with a volume ratio of 2 to 1. The resin became gelated within 20-40 minutes under isothermal reaction at room temperature. During this process, the viscosity of the liquid resin increased with curing time to form a clear solid block. The resin used in this example is used for countertop slab production and has significant resistance to UV degradation. FIG. 4 represents the yellowing effect of the corresponding products in comparison to general resin when laid under direct sunlight for 42 days. The modified resin only showed minor colouration with its 42 days-yellowing rating being equivalent to that of 7 days-yellowing rating in general epoxy. The result demonstrated that the modified resin had significantly higher resistance to UV degradation. Similar to engineering stone sold commercially, irrespective of the high UV stability of the resin used, the polymeric glass composite (PGC) produced may be recommended for indoor use.

### Coupling Agent

In a composite system, interactions between organic and inorganic materials may offer an inferior bonding adhesion capability due to the poor wettability on the surface of these two components. Resin binder contains hydrocarbon which is non-polar (hydrophobic), whereas glass powder is polar (hydrophilic). Therefore, obtaining good adhesion may be relatively difficult.

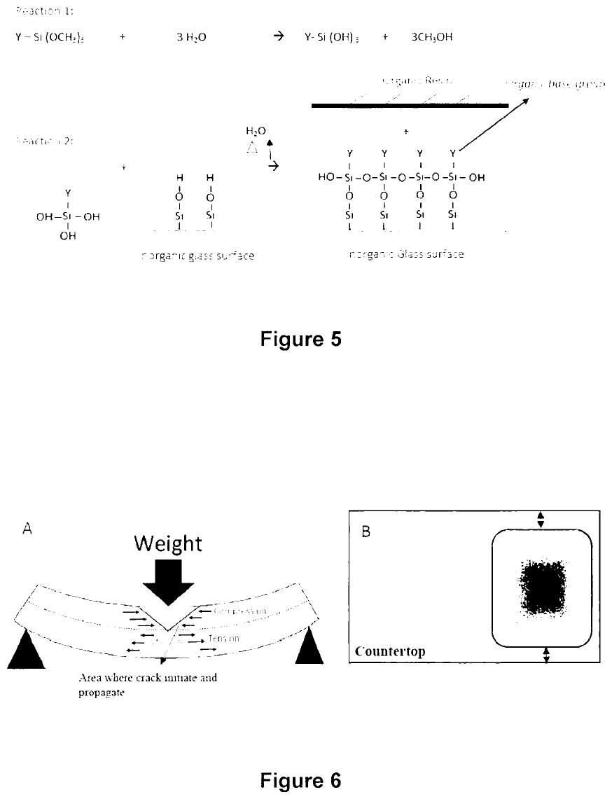

The interfacial adhesion in composite panels can, however, be improved by surface modification with the introduction of a coupling agent. Silane coupling agents are typically used for glass-polymer resin composites with one of the reactive groups binding with the surface of the inorganic materials and the other being copolymerised within the polymer matrix. The silane coupling agent used in this example was β-(3,4 epoxycyclohexyl)-ethytrimethoxysilane (CAS no. 3388-04-3) from Guangzhou Double Peach Fine Chemical Co., Ltd. The schematic of the interfacial modification is shown in FIG. 5 where Y is an organic base group with —(OCH₃)₃ reacted with water to form a reactive silanol (Si—OH). The diluted coupling agent (Y—Si(OH)₃) was mixed with inorganic glass powder surface to form a slurry. It was then dried in an oven at 100° C. overnight, leaving only silane-treated glass powder. From these reactions, the bridge between the organic base group of coupling agent and glass surfaces was built and the surface properties of the glass powder were improved to establish a bonding capacity with resin.

### Fibreglass Sheet

A sheet of fibreglass mesh can be added as a reinforcement to improve the flexural strength of the composite panels where required. While the sheet is not essential, it may be useful for thinner slabs, with narrow widths, which are made for table or countertop applications. In this example, the fibreglass was added in the tension region, as shown in the FIG. 6A, as this is where cracks start to propagate.

### Pigment

To create different appearances and designs, synthetic dye or coloured waste powder from ochre stone, hematite, and carbon was added. Copper and aluminium powder from e-waste could also be a useful addition to create glitter effects in the polymeric glass composite slabs produced.

### Manufacturing Process and Formulation

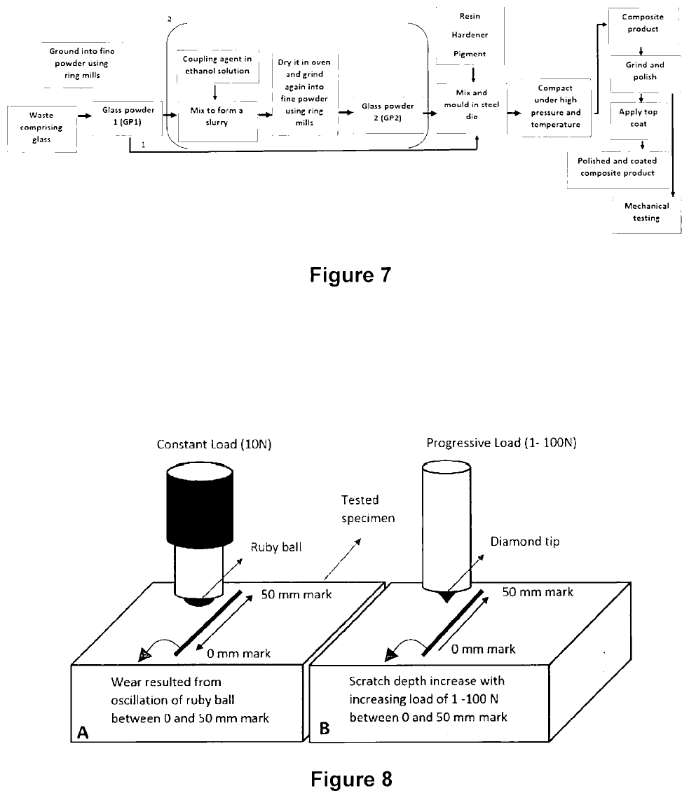

FIG. 7 illustrates the material preparation method and production steps taken to produce the polymeric glass composite panels. The raw materials were subjected to eight process steps. The process comprised crushing, grinding, pre-treatment of the glass powder, drying, mixing, moulding, hot pressing and cooling for disassembly. First, the mixed waste glass was crushed using a hammer or jaw crusher into 3-4 cm size aggregates and dried in an oven for 24 hours at 60° C. to remove any moisture. The waste glass cullet was then ground into fine powder using ring mills. Inside this machine, the sample was ground through vibration motion mechanism and was suitable for brittle materials. During this process, if laminated glasses were introduced, the PVB layer would stay in a 1 or 2 cm diameter globe and were easily removed by sieving through a 108 μm metal screen. At this stage, the glass powder was termed 1 (GP1) in the schematic. Further treatment may be appropriate if a silane coupling agent is used. Consequently, the glass powder 1 (GP1) was then dispersed in the solution of diluted alcohol and silane coupling agent to form a slurry. The alcohol from the slurry was evaporated in an oven overnight. After drying, the slurry formed a chuck of compacted powder. The compacted powder was then again ground using a ring mill to obtain glass powder 2 (GP2).

The waste glass powder (GP 1 or 2), resin, hardener and 0.5-2% pigment was combined in various proportions, as per formulae in Table 2, and mixed vigorously for at least 5 minutes to ensure homogeneity. The blend was then hand-laid in a 240×240 mm carbon steel die, lined with a non-stick Teflon sheet. The mixture was flattened and sealed with a square steel lid. The sealed die was loaded into a hydraulic hot press which was pre-heated to 80° C., and was then compacted under pressure of 550 bars for 30 minutes. The mould was then cooled to room temperature for at least about 30 minutes before the sample was removed from the steel mould.

TABLE 2
Panels formulation and design parameters in weight percentage (wt %).

| | | Glass | Resin compound | | | |
|---|---|---|---|---|---|---|
| | | powder | | Hardener | Silane coupling | |
| | Panel type | (<108 μm) | Part A resin | (Part B) in | agent in percent | |
| | (GP: Resin | in weight | in weight | weight | (relative to glass | |
| No. | compound) | percent | percent | percent | powder) | Pigment |
| 1 | A (65:35) | 65 | 23.333 | 11.336 | — | Pigment was only |
| 2 | B (70:30) | 70 | 20 | 10 | — | added for aesthetic |
| 3 | C (75:25) | 75 | 16.667 | 8.333 | — | purpose. The |
| 4 | D (80:20) | 80 | 13.333 | 6.667 | — | percentage varies |
| 5 | E (85:15) | 25 | 10 | 5 | — | depending on the |
| 6 | F (80:20) + 1% | 80 | 13.333 | 6.667 | 1 | targeted colour in |
| | silane (silane | | | | | the final product. |
| | percentage | | | | | Maximum pigment |
| | relative to glass | | | | | added is 2% to |
| | powder) | | | | | prevent any effect |
| 7 | G (80:20) + 2% | 80 | 13.333 | 6.667 | 2 | on the mechanical |
| | silane | | | | | properties. |
| 8 | H (80:20) + 3% | 80 | 13.333 | 6.667 | 3 | |
| | silane | | | | | |
| 9 | I (80:20) + 4% | 80 | 13.333 | 6.667 | 4 | |
| | silane | | | | | |
| 10 | J (80:20) + 5% | 80 | 13.333 | 6.667 | 5 | |
| | silane | | | | | |
| Note: | Powder glass filler along with resin binder account for 100% wt. | | | | | |
| | Coupling agent was added relative to powder filler and is added after everything else is measured. | | | | | |
| 11 | Marble stone | Reference samples available in the market. | | | | |
| 12 | Granite stone | These samples were cut and their mechanical properties were measured and compared with | | | | |
| 13 | Quartz stone | the PGCs produced. | | | | |
| 14 | Engineering | | | | | |
| | stone | | | | | |

### Mechanical Testing Procedures

The composite panels were further cut and polished into required slabs with sharp edges removed for mechanical testing. The panels were tested based on American Society for Testing and Materials (ASTM) standard and were designed for countertop use. The test includes bending, compression, wear and scratch resistant, water absorption and thermal degradation test. At least 5 specimens were prepared for each test with the average value reported in the result. Unlike ceramics, the percent error of the specimens tested was relatively low with a standard deviation of less than 5% due to the homogeneity in the produced samples and ductile properties retained from the resin binder.

### Four-Point Bending Test

The flexural strength or modulus of rupture (MOR) of material is defined as its ability to resist deformation under load. This property may be important when assessing the performance of engineered stone, or comparable products. The flexural strength value in this study was measured based on International standard ASTM C880/880M using Instron 5982 universal mechanical testing machine. Load at a uniform stress rate of 4 MPa/min was applied to failure. The dimension of the specimen tested was 240×100×18 mm with span of 180 mm.

### Compression Test

The compressive test is used to measure the maximum amount of compressive load a material can bear before fracture. The compression value in this example was measured based on International standard ASTM C170/C170-16 using Instron 5982 universal mechanical testing machine. At least 8 specimens were tested in perpendicular and parallel orientation. However, no significant difference was found in both orientations. The dimension of the specimen was 18×18×18 mm³ with a ratio of the height and diameter in error range of 0.9:1.0 and 1.1:1.0). Load at a uniform rate of 0.5 MPa/s was applied until the specimen failed.

### Water Absorption

Water absorption behaviour may be measured to determine the durability of the PGCs when exposed to high moisture environmental conditions. The samples were first weighed dry, then immersed in water for 24 hours. They were then surface dried with a damp cloth and weighed to the nearest 0.01 gram. By measuring the weight difference between the dry and wet samples, water absorption can be calculated based on the equation 1.

$$Absorption , weight \% = [ \frac{( B - A )}{A} ] \times 100 \qquad ( 1 )$$

### Where

A=weight of the dried specimen, (g) and
B=weight of the specimen after immersion, (g)

### Thermogravimetric Analysis

The thermogravimetric analysis (TGA) was measured by PerkinElmer STA 6000 in an inert nitrogen atmosphere with a flow rate of 20 l/min. The analysis measured mass of a sample over time as temperature changes. In this example, the TGA was used to identify the minimum temperature when the sample degraded (thermal degradation) which was also the maximum service temperature of the corresponding sample. The sample was heated from 30-1000° C. at a heating rate of 20° C./min and its weight loss was recorded.

### Flame Retardant Testing

Flame retardant testing assesses the propagation of flames under specified fire test conditions. The test conditions are based on the Underwriters Laboratory of United State (UL 94) and are used to serve as a preliminary indication of plastics acceptability for use as part of an appliance concerning its flammability. Based on the material properties to resist fire, the rating system is classified into 2 categories, i.e. Horizontal burn (HB) and Vertical burn (V2, V1, V0). The schematic is shown in Table 3 below. At least 10 specimens with a dimension of 5.0×0.5×0.118 inches are prepared for each test of horizontal and vertical testing.

### Scratch and Wear Testing

Scratch testing in this example was conducted using Macro scratch tester as illustrated schematically in FIG. 8A. A stylus with sharp diamond tip was moved over a specimen surface with ascending load from 0-100 N with a scratch length of 50 mm. The penetration depth also increased progressively from 0 to 50 mm mark. The penetration depth profile of PGC produced in this study was then compared with commercial natural and engineering stone.

Besides scratch testing, resistance of material to wear may also be a useful property. Wear testing evaluates the performance of products over time. The schematic of the wear testing is shown in FIG. 8B using Tribometer. A ruby ball of 5 mm diameter under an applied load of 10 N was used to indent the samples and oscillate from 0 to 50 mm mark for 6000 cycles at 5 cm/s. The depth profile was then measured under profilometer. The intent of wear and scratch testing in this study was to produce data that will reproducibly rank the new materials with the existing products under a specified set of conditions.

### Workability and Trapped Air Bubbles

The workability of the pre-cured PGC paste is largely influenced by the viscosity of the resin and glass powder mixture. A goal is to identify an optimal formula for creating a product with desirable mechanical and physical properties without trapped air bubbles. The percentage of resin used was adjusted from 15 to 35%. This range was selected for two main reasons. A mixture of more than 35% resin has lower viscosity and is easily workable but will result in a softer panel. By lowering the resin percentage, the end products are stiffer, imitating a stone-like panel. Secondly, as the percentage resin is a key factor in determining the production costs of the waste glass composite panels, minimising the amount can also reduce costs.

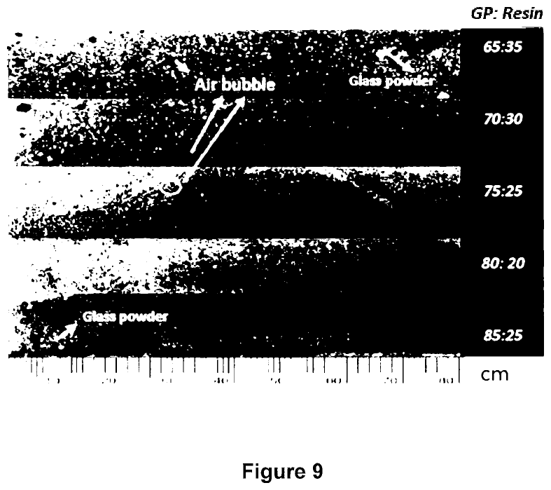

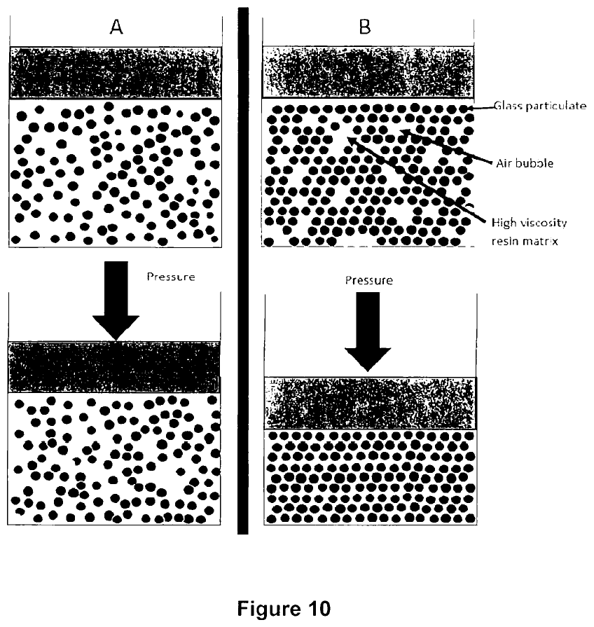

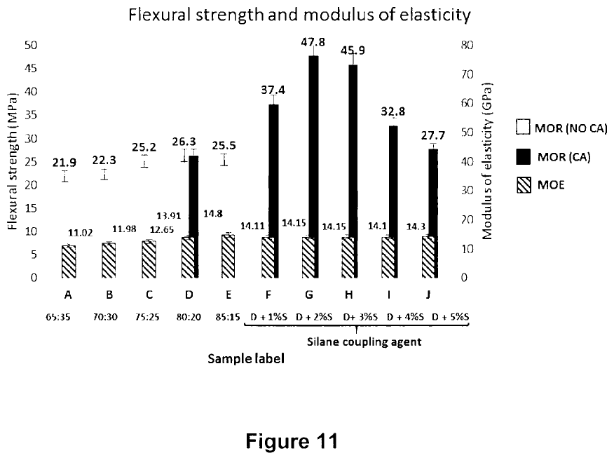

With 15-35% resin percentage, the mixture was useful but was found to have low workability, resulting in a high volume of trapped air bubbles. To reduce the air bubbles, more precise adjustments of the viscosity and high production pressure were appropriate. Viscosity could be altered by adjusting the glass and resin ratio. An acceptable proportion of resin was found to be between 15 and 25% with a particularly useful ratio of glass/resin for creating a free air-trapped product is 80:20 as shown in FIG. 9. In this viscosity range, the mixture was very stiff but not tacky. It behaved like solid with liquid (wetting) (FIG. 10B) rather than suspension (FIG. 10A). Trapped air could easily be removed by applying high constant pressure and heat. This was because the liquid binder gives sufficient, and not excessive, coverage to the powder; the powder did not float around in the liquid binder. Rather, it acted like wet sand and could be easily compacted using a trowel or pressure. This characteristic allowed the powder particulates to re-arrange, closing the void/air bubble under high pressure. It is also noted that lower viscosity than the range stated would result in a tacky mixture with strong liquid tension (suspension characteristic).

### Flexural Strength (MOR) and Modulus of Elasticity

Flexural strength, along with density, plays an important role in determining the dimensions of the product produced, especially in table/countertop production in which the beam system is used. Beams span open spaces and are internally self-supporting. Therefore, higher flexural strength and moderate density may be desired.

### Effect of Porosity on MOR and MOE

As can be seen from FIG. 11 (A-E), a maximum flexural strength of PGCs without silane coupling agent was 26.3 MPa with glass/resin ratio of 80/20. The improvement might be due to better compaction, smaller porosity and fewer air bubbles in the product compared to other different ratio samples as shown previously in FIG. 9. According to Venkatesh et al. 2016 (Proc. 13th World Conf. Titanium), cracks begin with extreme-sized pores and grow across a specimen, leading, finally, to fracture. The fine pores present in the samples do not seem to affect their ductility and strength significantly. The smaller/negligible porosity of the 80/20 ratio PGC has, therefore, produced a stronger product.

It was also found that there was a linear correlation between the MOE and glass powder loading. MOE, also known as the flexural modulus is a mechanical property that measures the composite's stiffness. The higher the value, the better composite's resistance to elastic deformation under load or the stiffer the material. Low MOE materials are flexible and tend to deflect considerably under load. By comparing panel A-E, it was observed that stiffness increased with increasing glass powder content. The increase was mainly due to the addition of high density of glass powder replacing a certain amount of bendable resin binder.

### Effect of Coupling Agent on MOR and MOE

By comparing panel D, F and G, it was apparent that the addition of the coupling agent played a significant role in increasing the flexural strength of the PGCs. Average improvements in flexural strength of more than 40% were observed in these samples, in comparison to control sample (D). The flexural strength increased from 26.3 for panel D to a maximum of 47.8 MPa in panel G, when 2% of silane coupling agent was added. In panel D, interfacial adhesion was relatively weak due to the relatively poor wettability on the surface of glass powder and resin. A relatively weak interfacial region reduced the efficiency of stress transfer along the matrixes, thus resulting in relatively low flexural strength. On the contrary, in panel C, surface modification between these two components was achieved with the addition of silane coupling agent. Wetting of resin on glass powder was more pronounced, resulting in significant improvement in adhesion and compatibility. These increases allowed better stress transfer and thus improved the bending strength of the PGCs. The improvement was also shown from the SEM analysis which was performed post mechanical testing of the samples.

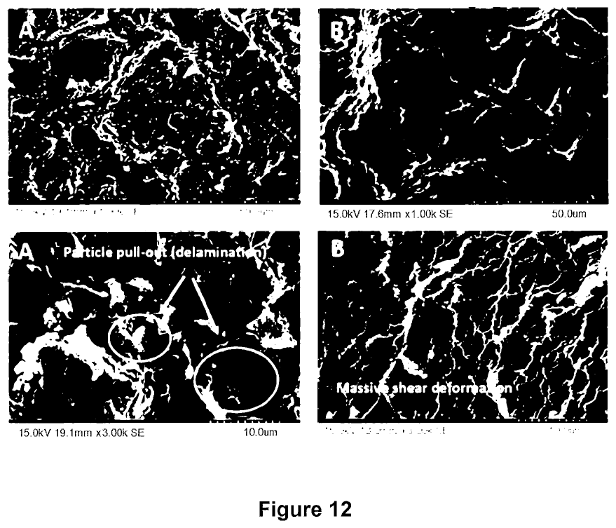

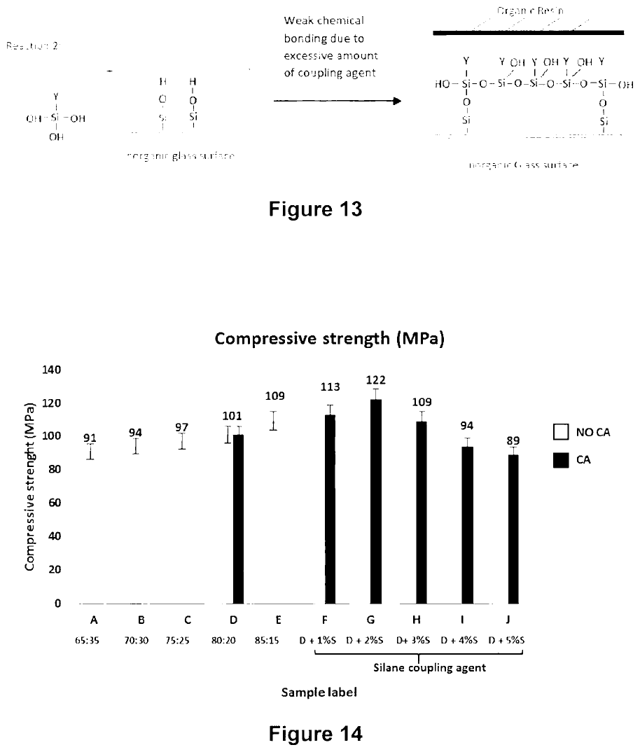

In FIG. 12A, it was observed that a rough surface with several pores and air gaps occurred at the fracture surface when no coupling agent was added. The rough surface which was due to particle pull-out implied that the bonding between the powder filler and resin was relatively weak (delamination). These products may nevertheless be useful in certain applications. In contrast, the fracture surfaces of the PGC samples with the coupling agent (FIG. 12B) showed shear deformation. The strong bonding among all components prevented delamination and encouraged shear yielding before failure. More energy was absorbed by such shear deformation which led to improvements in the bending strength values.

As shown in FIG. 11 (H-J), further additions of coupling agent, however, showed a reverse effect on the MOR. As the volume of coupling agent increased, the surface glass powder was covered by —OH again, leading to reduced compatibility and interface bonding with the resin (FIG. 5).

### Compressive Strength

FIG. 14 (A-E) shows that the compressive strength of PGCs increased from 91 to 109 MPa with increasing glass content from 65 to 85 percent weight. In all tested samples, the higher the glass content, the more difficult it was for a crack to propagate, resulting in higher compressive strength. The improvement might also be due to better compaction, smaller porosity and fewer air bubbles in the product.

By comparing panels F-J with D, it could be seen that the addition of coupling agent resulted in improvements in an average compressive strength of panel D (80:20, without coupling agent) from 101 to a maximum value of 122 MPa in panel G when 2% of silane coupling agent was added. The increase was due to the enhanced bonding capacity between the resin and glass.

Comparison with the Standard

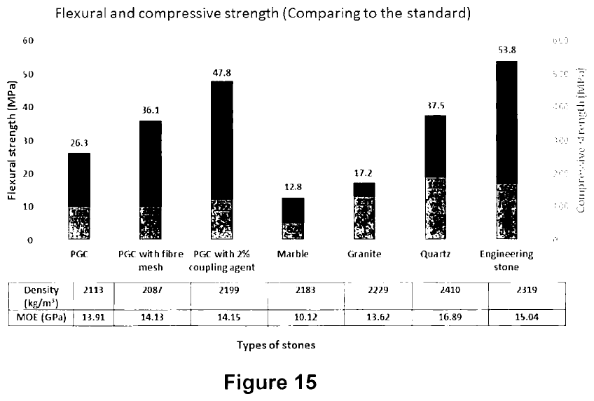

By comparing the PGC samples produced with natural stone (FIG. 15), it was found that PGCs offered superior performance in both flexural strength and density. In terms of flexural strength, PGCs with a silane coupling agent were three times more resistant to bending than natural stone (marble and granite) and exhibited comparable properties to quartz and engineered stone. It is important to note that although both natural granite and quartz was composed from the same crystalline SiO₂, the natural granite collected in this study had larger particle sizes (2-4 mm) compared to auartz which might degrade its bending strength. Even without the addition of a coupling agent, the flexural strength of the PGC samples was adequate for countertop or tabletops applications. If thinner sections of the PGCs are desired, a sheet of fibreglass can be added as an alternative to the coupling agent. The addition of fibreglass mesh and silane coupling agent to the PGC improved flexural strength by up to 37% and 80%, respectively. Besides flexural strength, the densities of various PGCs were also slightly lower compared to natural or engineered stone. This was due to the use of 20% resin which has a density of 1.83 g/cm³.

The stiffness of PGC and engineering stone was also found to be higher compared to marble and granite stone. Quartz, granite, glass and engineering stone which are composed of SiO₂ have stronger bonding compared to CaCO₃ in marble stone, which affects its stiffness. In granite stone, impurities such as feldspar, mica, amphiboles and other minerals might reduce the strength as well as the stiffness. It can also be seen that the stiffness of engineering stone and quartz are 16.89 and 15.04 GPa respectively. Although engineering stone was made from the same materials as natural quartz, the ductile properties of resin addition in engineering stone might be the result of the decrease in stiffness. The decrease was, however, not very significant.

Further observation of quartz and glass were also investigated in this example. Unlike quartz which has strong covalent bonds that hold the silicon and oxygen in arranged covalent structure, the addition of Na₂O structure in glass disrupts the structure of quartz by adding oxygen atoms more than those required for an interwoven tetrahedral structure. The bonding in glass is slightly inferior compared to quartz based stone, thus affecting the stiffness. The stiffness of glass, however, was still relatively high compared to marble and granite, with a small decrease of MOE due to resin addition in PGCs. Regardless of the variation in the MOE value, all the samples tested were very stiff and underwent brittle failure with minimum deflection during testing.

The combination of low density, high stiffness and flexural strength in both PGCs and engineered stone, when compared to natural stone products, may be expected to facilitate the production of thinner PGC countertop slabs with longer spans. This creates a new sustainable solution in providing path-breaking building product which will lead dematerialisation.

### Scratch Resistance Test

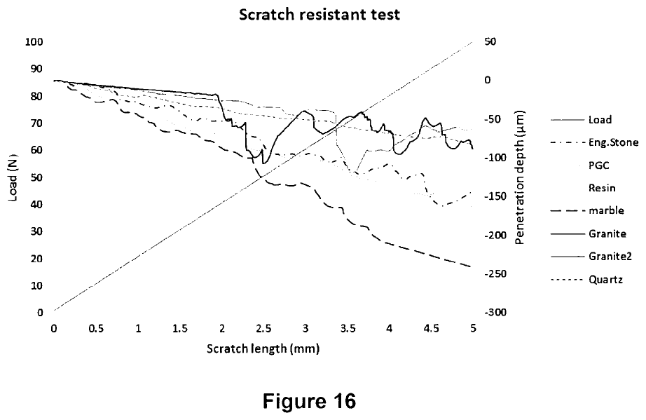

FIG. 16 illustrates the penetration depth of the tested samples at increasing load of 1-100 N within 5 mm scratch length. It was observed that the penetration depth in PGC increased linearly with a load from 0-160 μm. The value was comparable to engineering stone with a depth of 0-150 μm. The slightly lower scratch resistant values in PGC was due to the nature of glass which has a lower hardness (Mohs hardness: 5.5) compared to engineering stone which is comprised mainly of Quartz powder (Mohs hardness: 7). Furthermore, by comparing resin alone with PGC, it was also observed that the scratch-resistance increased nearly two-fold with the addition of glass powder filler. All the synthetic stones produced, however, showed inferior performances in comparison to natural granite and quartz but demonstrated a higher scratch resistance value than marble. Quartz and granite had a penetration trend line of −15 μm/cm and −12 μm/cm respectively. This was due to the harder crystalline SiO₂ fillers that made the materials. Regardless of the loading rate, some impurities in granite, however, resulted in deeper scratch depth.

### Wear Testing

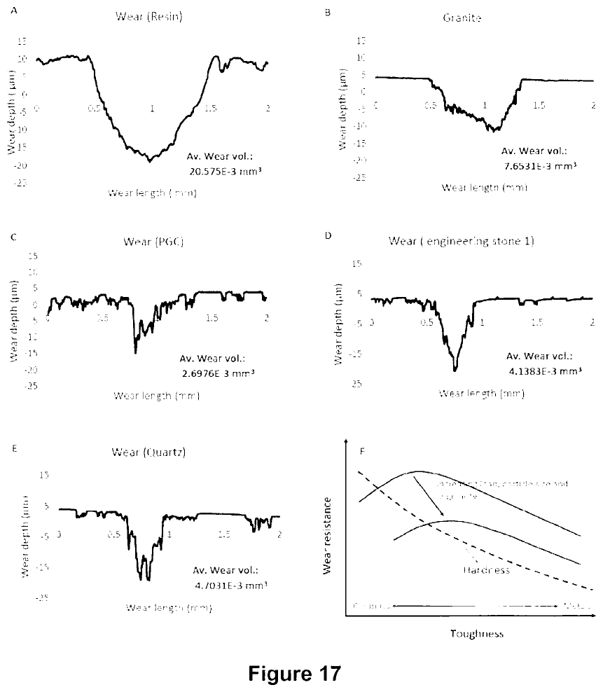

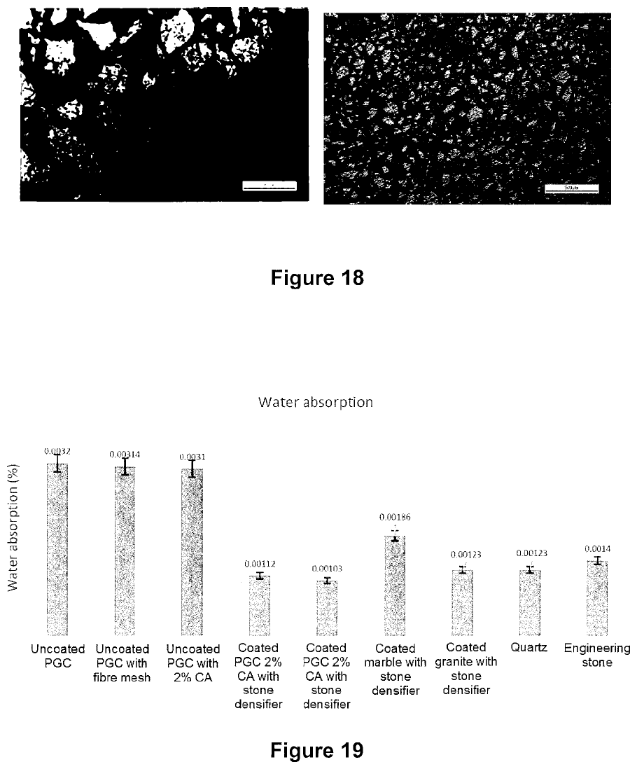

FIG. 16 illustrates the penetration depth profile of the tested samples under wear testing for 6000 cycles at 10 N load. The graph of the wear was drawn using profilometer. It was then followed by plotting the data in Excel and transfer to AutoCad to get an accurate measurement of wear depth area. It could be observed in the graph that PGC had the least wear with wear volume of 2.6976 E-3 mm³. The better performance of PGC in comparison to engineering stone (wear volume 4.1383) was due to the use of finer powder filler (<108 μm) in PGC production. In contrast, the particle size of engineering stone was shown under an optical microscope in FIG. 18 to be about 0.05 mm in diameter. Larger particles cause more extensive wear as they carry more kinetic energy. Similarly, a natural quartz and granite which comprise larger angular aggregates showed inferior performance with wear area of 4.7031E-3 and 7.6531E-3 mm³ respectively compared to both the artificial stones. The size and shape of natural SiO₂ stone affect the rate of wearing with angular particles causing greater wear than round particles. The natural quartz was made from finer particles (0.1-0.5 mm size) compared to granite with particle size ranging from 2 to 4 mm, which results in better wear performance of quartz. Higher impurities in granite compared to Quartz stone might also be the reason of the inferior performance of granite. Besides size, shape and impurities, hardness also plays an important role in wear. Brittle material like ceramics and natural stone usually suffer wear by brittle fracture with ductile materials like metal, plastic and resin suffering wear by plastic deformation. The resin used in this example was ductile and produced wear volume of 20 E⁻³ mm⁻³ under the same experimental condition, nearly three-fold compared to all the tested samples. According to research conducted in University of Cambridge (Tribology and Wear; 2016), a maximum wear resistance arises through a combination of intermediate values of hardness and toughness as shown in FIG. 17F. PGC and engineering stone which comprise a combination of ductile resin and brittle powder therefore performed better in wear. Wear-resistance of marble stone was not reported due to excessive wear at only 1000 cycles.

### Water Absorption

FIG. 19 summarises the water absorption of the tested samples. It was observed that the PGC samples without coating show average water absorption of around 0.003%. An improvement to 0.00112% was observed with the addition of stone sealer. The stone sealer used in this study was granite gold sealer which is non-toxic and safe as a food preparation surface. After the addition, the value is comparable to that of coated natural stone and engineering stone existing in the market. Without the coating, marble and granite are porous and were reported to absorb nearly 0.06 and 0.04% of water respectively (Kessler, Technological Papers of the Bureau of Standards, 1919). The uncoated values of PGCs were found to be lower compared to the natural stone. No significant improvement in water resistance was observed with the addition of coupling agent and fibre glass mesh. In this example, immersed specimens had also been tested under flexural and compression test. However, no significant differences were observed due to a negligible amount of water absorbed by the specimens.

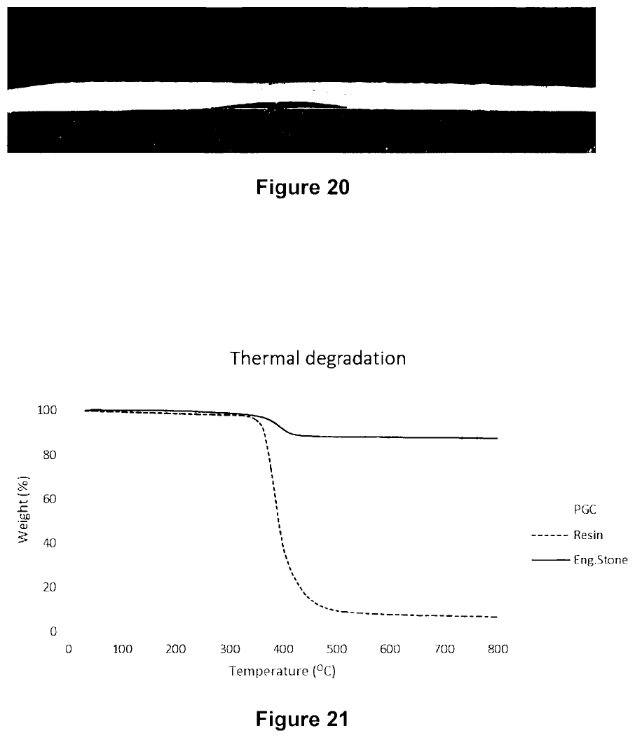

Dimension stone countertop manufacturers often offer additional coatings; such coatings can similarly be applied to give extra protection to the PGCs. Polyurethane (PU) or polyasparthic coating about 0.1 mm thick provided extra resistance to water, stains and ultraviolet (UV) in the final coated PGC product. However, a light sanding of the uncoated PGC surface may be appropriate before applying the polyurethane coating to prevent delamination, as shown in FIG. 20.

### Thermal Degradation and Scorch Testing

Thermal degradation analysis estimates the maximum service temperature of materials, especially polymers which may lose their mechanical strength at relatively low temperature. The degradation was measured by using thermogravimetric analysis (TGA). PGC and engineering stone comprise a polymer binder. At elevated temperatures, the components of the long chain backbone may break apart. It can be seen from the FIG. 21 that PGC and engineering stone began to degrade at around 270° C. with maximum degradation occurring after 350° C. which fell at the same degradation temperature as the resin binder. PGC was observed to have more weight loss compared to engineering stone with loss of 18% and 12% respectively. This might be due to the use of a smaller amount of resin in engineering stone (7%) compared to PGC (20%). Regardless, the service temperature of these two materials fell in the same category.

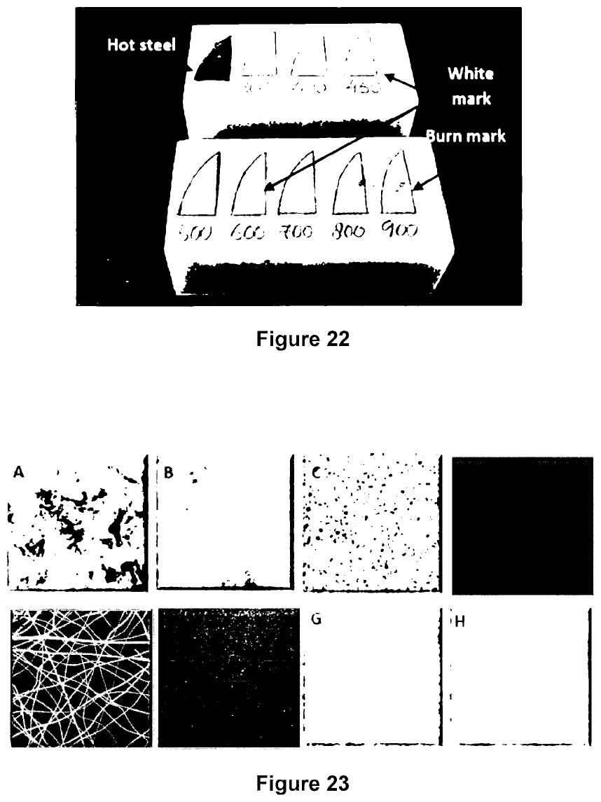

Besides TGA, scorch testing was also conducted in this study as shown in FIG. 22. A hot steel with temperature ranging from 200 to 1000° C. was placed on top of a PGC sample for 30 minutes. No apparent defect was observed in the PGC at a temperature below 400° C. However, similar to engineering stone which was made from resin binder, it was recommended to put a trivet or barrier between a hot material and the PGC surface. As shown from TGA analysis, strength might be compensated at a temperature above the degradation temperature.

### Flame Retardant Testing

TABLE 4
Flame retardant testing of different stone composite

| | | Vertical burn |
|---|---|---|
| | Horizontal | (Ave. total |
| Samples | burn | flaming combustion) |
| Resin | Pass (12.7 mm/min) | Fail |
| PGC | Pass (self-extinguish) | V1 (<225 secs) |
| PGC with 2% CA | Pass (self-extinguish) | V1 (<216 secs) |

Commercial samples

| Marble | Natural stones do not contain polymer binder, | |
|---|---|---|
| Granite | and passed all the required flame retardant test. | |
| Quartz | | |
| Engineering stone | Pass (self-extinguish) | V1 (<210 secs) |

PGCs comprise resin binder that is categorised as a plastic material. The flame-retardant testing is based on Underwriters Laboratories of the United States (UL 94) and is used to serve as a preliminary indication of plastics acceptability for use as part of a device or appliance with respect to its flammability. The rating system is categorised into 6 types, i.e. HB (least flame retardant), V2, V1, V0, 5VB to 5VA (most fire retardant). Most of the tested samples passed the horizontal burn test with PGC and commercial engineering stone showing self-extinguish properties when laid flat. This test was particularly important considering the slab produced could serve horizontally as countertop, tiles and table. The cured resin itself also had considerable resistance to flame spreading of 12.7 mm/min. Unlike thermoplastic which tends to soften and flow at high temperatures, thermosetting resin does not soften but undergoes localised surface charring which impedes the spread of flame. Furthermore, it was observed from the table that the fire-resistant property increased with the addition of glass powder. The improved fire resistance observed was largely due to the non-flammable and non-combustible nature of glass powder, which provided temporary barriers to the flame as it spread along the WPCs. Furthermore, the minor amount of sodium silicate in the glass powder might also play a role in these improvements. Sodium silicate has been widely used as passive fire protection. It has a synergistic effect on the intumescent flame retardant (IFR) when exposed to an open flame. It increases in volume and decreases in density, forming char at higher temperatures. The char is a poor heat conductor, preventing the fire from spreading further. From the graph, it could also be observed that the PGC produced passes the vertical burn test (V1) with total combustion time for 5 times not exceeding 250 seconds and no flaming drips observed.

### Improving the Aesthetic Look of PGC

A range of colours, effects and ‘looks’ for the PGCs was developed using waste materials, coloured stone powder and synthetic liquid pigments, as shown in FIG. 23. Sample A was made by using 0.2% carbon powder and 1% of white liquid pigment. The swirling effect was the result of the partial mixing of the coloured materials with the pre-mixed glass powder-resin mixture. Similarly, the blue product (FIG. 23B) was made using the same process, but with 1.2% blue and white liquid pigment. Other samples, such as FIG. 23C, had been made with the addition of glass aggregates. Additives such as copper powder from e-waste, quartz stone fragments, sea shell from food waste can be embedded in the mixture before casting. These samples showed that other waste materials could also be absorbed into the PGCs to improve their aesthetic look, providing a cost-effective ‘waste-derived’ product that is comparable to natural dimension stone.

### Example 2

### Powder Filler

The chemical composition of various powder fillers was analysed using X-Ray Fluorescence (XRF), as shown in Table 5. The main filler in this example comprises SiO₂ and CaCO₃. Quartz, sand and glass contained mostly SiO₂ with a small proportion of Na₂O in the glass. The XRD analysis of the silica-based powder was reported with quartz and sand having crystalline structure and glass being amorphous. Other types of stones investigated in this study comprised calcium oxide and CO₂ off-gas with dolomite and concrete containing MgO and SiO₂ respectively.

TABLE 5
XRF elemental analysis of different waste powder filler in weight percentage (%)

| Compound | Na₂O | MgO | SiO₂ | CaO | Al₂O₃ | LOI (CO₂) |
|---|---|---|---|---|---|---|
| Quartz | 0.000% | 0.000% | 99.000% | 0.000% | 0.000% | 0.82% |
| Sand | 0.082% | 0.034% | 94.744% | 0.021% | 1.821% | 0.52% |
| Glass | 11.70% | 2.96% | 72.66% | 6.9% | 0.87% | 0.91% |
| Sea shell | 1.003% | 0.241% | 0.022% | 53.348% | 0.000% | 45.335% |
| Limestone | 0.032% | 0.586% | 1.867% | 52.770% | 0.557% | 46.245% |
| Dolomite | 0.100% | 20.38% | 5.221% | 31.943% | 0.0030% | 42.980% |
| Concrete | 0.230% | 1.247% | 15.51% | 45.854% | 3.655% | 29.760% |
| LD CaCO3 | 0.030% | 0.360% | 0.321% | 54.50% | 0.072% | 43.98% |

Important characteristics of powders include the particle size (granulometry) and particle shape (morphology). Properties of powders (bulk density, flowability, surface area etc), as well as the potential areas of their application, may depend on these characteristics. In this example, the granulometry of the fine powder was kept constant. All the powder filler, except for low-density CaCO₃, was shifted through metal screening to a size of between 64-108 μm. The small particle size is intended to form homogenous colour mixture when mixed with resin. It was also found in this example that particles smaller than 64 μm may tend to clump.

Particle morphology of the powder filler was identified using Scanning Electron Microscope (SEM) analysis.

### Resin Binder

The resin used in this example was marine-based epoxy, namely Epoxy-80 with characteristics of medium viscosity, non-toxic, good chemical and abrasion resistance. It is used for bar tops and flooring and has resistance to UV degradation. The resin was mixed with hardener at a volume ratio of 1 to 1. The thermal degradation temperature of the resin was measured by PerkinElmer STA 6000 to be 350° C. The resin only showed minor coloration with its 42 days-yellowing rating being equivalent to that of 2 days-yellowing rating in general epoxy.

### Coupling Agent

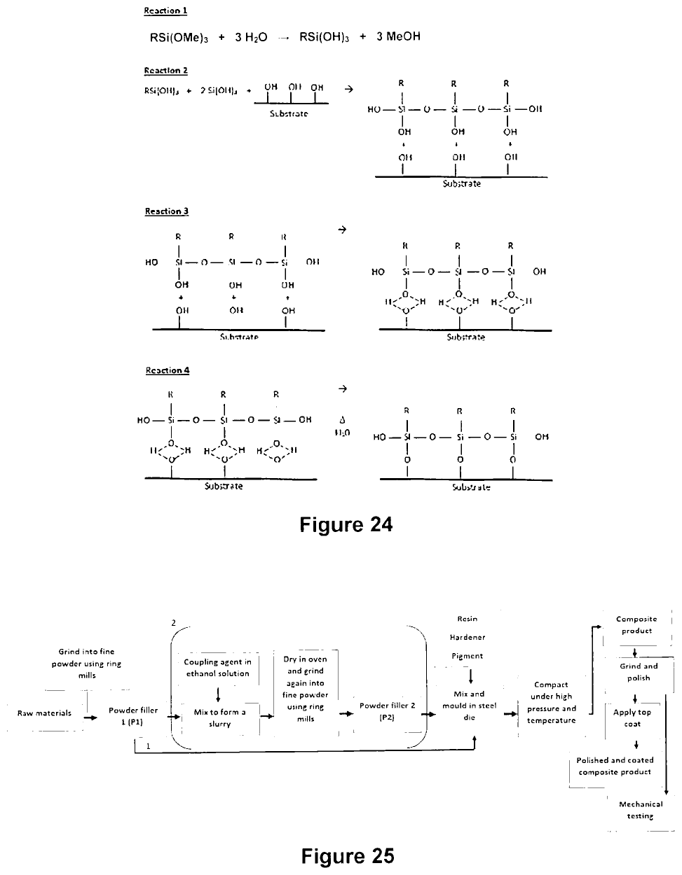

In this example, amino-based compatibilizer with a chemical formula of 3-aminopropyltriethoxysilane was chosen. The CA was supplied from Guangzhou Double Peach Fine Chemical Co., Ltd. The CA was used to provide surface modification of non-polar materials and improve its wettability with resin binder. The coupling agent is suited for epoxy resin and inorganic fillers, typically silica-based components. Amino functional silane coupling agent also adheres well to CaCO₃ filler surface. The coupling agents act as a bridge between the powder filler and matrix and help in improving adhesion as well as load and stress transfer. The interface modification of CA to glass powder is presented in FIG. 24.

The reaction of the silane with powder filler involves four steps. The process comprises hydrolysis, condensation, hydrogen bonding and bond formation. Initially, when mixing the coupling agent with water, hydrolysis of the three labile groups occurs. The diluted coupling agent is then mixed with powder filler to promote reaction 2. Upon mixing with a mixer, the reactive groups of silane coupling agent that possess a hydrolytically sensitive centre will bind with the surface of the inorganic materials, forming a hydrogen bond. As water is removed, generally by heating it at 100° C. for 24 hours, covalent bonds will proceed with a certain amount of reversibility. Bonds will form, break and reform to relieve internal stress forming compounds in reaction 4. When mixing the treated powder compound with resin, the organic end of the coupling agent will react with polymer matrix. The overall bonding results in high mechanical properties.

### Manufacturing Process and Formulation

FIG. 25 summarises a material preparation method and the production step for producing powder-resin composite panels. Firstly, the stone aggregate, concrete blocks, glass cullet and seashell are ground individually into fine powders using ring mills and sifted through metal screening to a size of between 64-108 μm. The powder filler was then dried in an oven at 100° C. for 24 hours to remove any remaining moisture. At this stage, the powder filler is termed 1 (P1) in the schematic. When a silane coupling agent is used further treatment may be appropriate. Consequently, the powder filler 1 (P1) was then dispersed in the solution of diluted alcohol and silane coupling agent to form a slurry. The alcohol from the slurry was evaporated in an oven overnight. After drying, the slurry forms a chuck of compacted powder. The compacted powder was then again ground using a ring mill to obtain powder filler 2 (P2).

The powders (P 1 or 2) along with the resin binder were combined with a ratio of 80 and 20 respectively, and were then mixed vigorously with a high-speed mixer for at least 5 minutes to ensure homogeneity.

A releasing agent was applied to a 240×240 mm carbon steel mould before the wet mixture was hand laid in the mould. The die was sealed and compacted under a high compression pressure of 550 bars, and at temperatures of 80° C. Finally, the samples were cut, ground and polished into a slab with sharp edges removed for mechanical testing.

### Four-Point Bending Test

The flexural strength or modulus of rupture (MOR) of a material is defined as its ability to resist deformation under load. This property may be important when assessing the performance of engineered stone, or comparable products. The flexural strength value in this example was measured based on International standard ASTM C880/880M using Instron 5982 universal mechanical testing machine. Load at a uniform stress rate of 4 MPa/min was applied to failure. The dimension of the specimen tested was 240×100×18 mm with span of 180 mm.

### Compressing Test

The compressive test is used to measure the maximum amount of compressive load a material can bear before fracture. The compression value in this example was measured based on International standard ASTM C170/C170-16 using Instron 5982 universal mechanical testing machine. At least 8 specimens were tested in perpendicular and parallel orientations. However, no significant difference was found in either orientation. The dimension of the specimen was 18×18×18 mm³ with a ratio of the height and diameter in error range of 0.9:1.0 and 1.1:1.0. Load at a uniform rate of 0.5 MPa/s was applied until the specimen failed.

### Water Absorption

Water absorption behaviour may be measured to determine the durability of the PGCs when exposed to high moisture conditions. The samples were first weighed dry, and then immersed in water for 24 hours. They were then surface dried with a damp cloth and weighed. By measuring the weight difference between the dry and wet samples, water absorption can be calculated.

### Thermogravimetric Analysis

The thermogravimetric analysis (TGA) was measured by PerkinElmer STA 6000 in an inert nitrogen atmosphere with a flow rate of 20 l/min. The analysis measured mass of a sample over time as temperature changed. In this example, the TGA was used to identify the minimum temperature when the sample degraded (thermal degradation) which was also the maximum service temperature of the corresponding sample. The sample was heated from 30-1000° C. at a heating rate of 20° C./min and its weight loss was recorded.

### Scratch Testing

Scratch testing in this study was conducted using Macro scratch tester. A stylus with sharp diamond tip was moved over a specimen surface with ascending load from 0-100 N with a scratch length of 50 mm. The penetration depth also increased progressively from 0 to 50 mm mark. The penetration depth profile of PGC produced in this study was then compared with commercial natural and engineered stone.

### Powder-Resin Composite

The composite panels in this example are designed to replicate the natural look of marble, granite, travertine, terrazzo and solid colour panel.

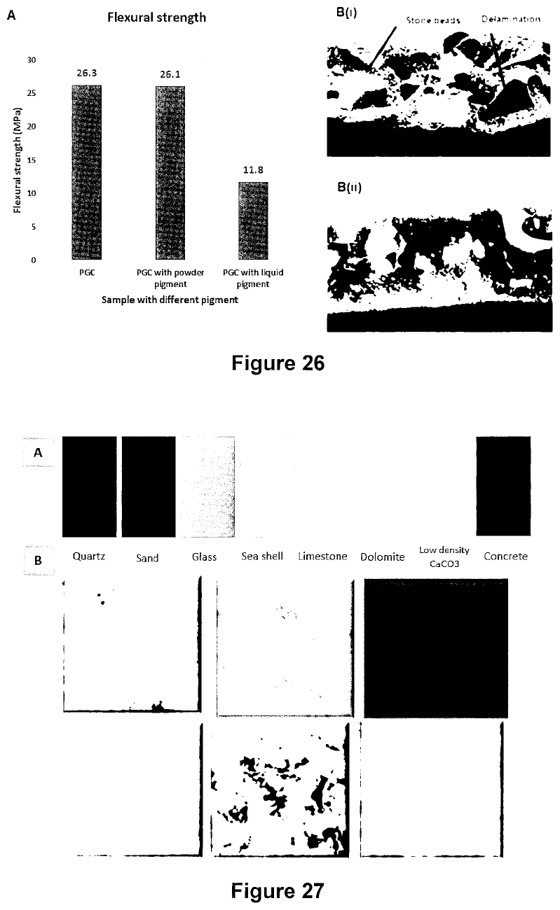

Liquid pigment has been a preferred material for craft makers when colouring resin. Usage of not more than 2% of pigment loading is often recommended. To test this hypothesis, an investigation of the effect of pigment on the mechanical properties of resin was conducted. Appearance wise, no significant differences was observed. It was, however, found in this example that flexural strength degraded from 26.3 to 11.8 MPa, although both strengths are still useful. The degradation is the result of the relatively weak bonding between the resin and powder filler. This was observed from the particle pulling-out on the composite panel when loaded under flexural test (FIG. 26B(i)). To prevent this phenomenon, powder pigment may be preferred.

Wastes and off-cuts from a stone manufacturer may be used as alternative materials to yield different aesthetic outcome. As shown from FIG. 17A, all of the different materials collected produce different colour panels. The mechanical properties also varied. The panels in FIG. 27B were made from combined fillers listed in FIG. 27A. The swirling effect like marble was the result of the partial mixing of the coloured materials with the pre-mixed powder-resin mixture. The strength of the marble panels is the average value of two powder filler used.

### Flexural Strength and Stiffness (MOE and MOR)

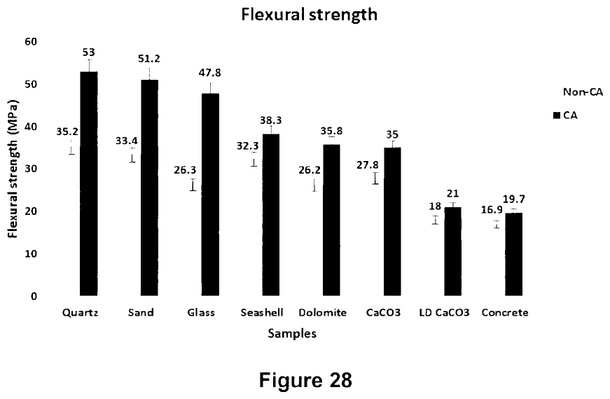

Flexural strength and moderate density may be desired in certain circumstances. FIG. 28 summarizes the average flexural strength of the panels produced in this example.

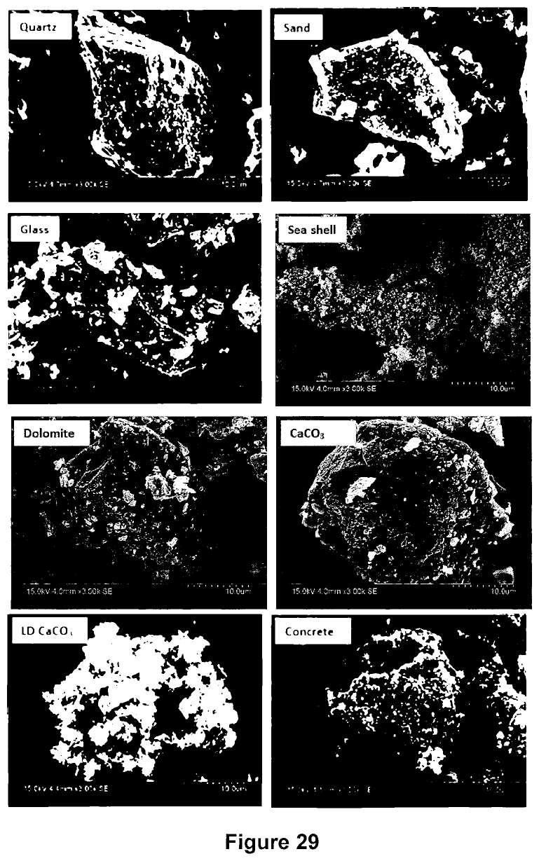

Effect of powder morphology on the flexural strength of powder-resin composites From FIG. 28, it can be seen that composite made of quartz and sand offered superior performance in flexural strength, with an average value of 35.2 and 33.4 respectively. The rough surface morphology of these crystalline silica compound, shown in FIG. 29, adheres effectively with resin binder which might lead to better bonding and higher strength.

It was also observed in this example that composites made from seashell are comparable to those made from sand. The high surface roughness along with its fibrous nature may be the reason for its mechanical properties.

When untreated with a coupling agent, glass, dolomite and CaCO₃ have a comparable strength of approximately 26 MPa.

### Effect of Coupling Agent on the Flexural Strength of Powder-Resin Composite

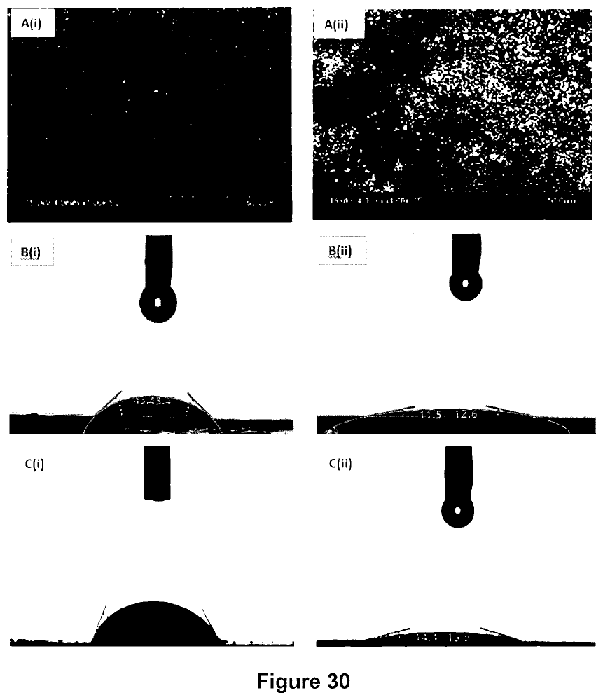

To achieve high flexural strength in the composite panels, adhesion between resin and powder filler should be increased. Strong adhesion may be influenced by good wettability of two similar components, generally through interaction between polar-polar or nonpolar-nonpolar constitutes. The powder fillers used in this example are polar and offer relatively less covalent bonding with a non-polar polymer resin. The interfacial adhesion in composite panels can optionally be enhanced by chemical modification with the introduction of a coupling agent. Silane coupling agents are typically used for powder-resin composites with one of the reactive groups binding with the surface of the inorganic materials and the other being copolymerized within the polymer resin matrix. FIG. 30(i) (ii) shows the glass substrate before and after silane coating respectively. Dispersion of hydrated silane was observed on the surface of the treated glass with a contact angle of resin on glass substrate decreasing from 43.4° to 12.05°. Similarly, improvement in wettability of resin on CaCO₃ substrate was observed in FIG. 30C with the average contact angle decreasing from 60° to 15°.

From FIG. 28, in all tested samples, it was apparent that the addition of a coupling agent played a role in increasing the flexural strength of powder-resin composites. In the non-coupled panels, interfacial adhesion was relatively weak due to the relatively poor wettability on the surface of powder and resin. A weak interfacial region reduced the efficiency of stress transfer along the matrixes, thus resulting in lower flexural strength. On the contrary, in the treated samples, surface modification between these two components was achieved with the addition of silane coupling agent. Wetting of resin on powder was more pronounced, resulting in an improvement in adhesion and compatibility. These increases allowed better stress transfer and thus, improved the bending strength of the composites. The improvement was also justified by SEM analysis which was performed post mechanical testing of the samples.

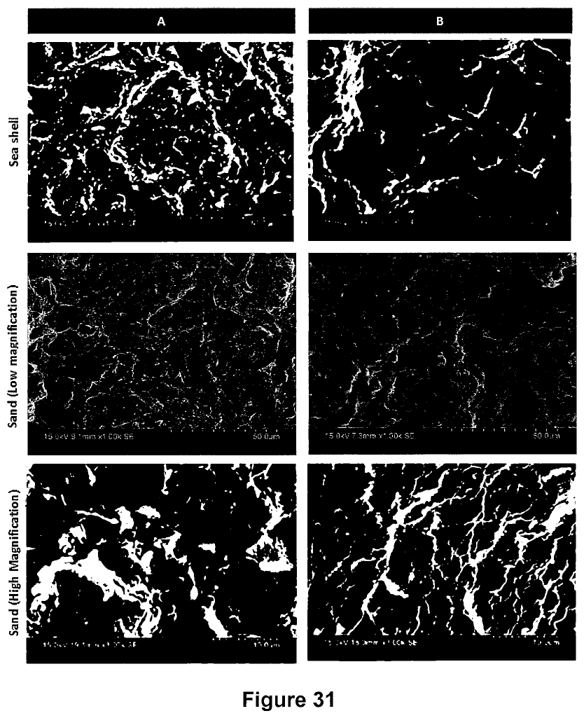

In FIG. 31A, it was observed that a rough surface with several pores and air gaps occurred at the fracture surface when no coupling agent was added. The rough surface which was due to particle pull-out implied that the bonding between the powder filler and resin was relatively weak (delamination) although the composite was still useful. In contrast, the fracture surfaces of the composite samples with the coupling agent (FIG. 31B) showed shear deformation. The strong bonding among all components prevented delamination and encouraged shear yielding before failure. More energy was absorbed by such shear deformation which led to improvements in the bending strength values.

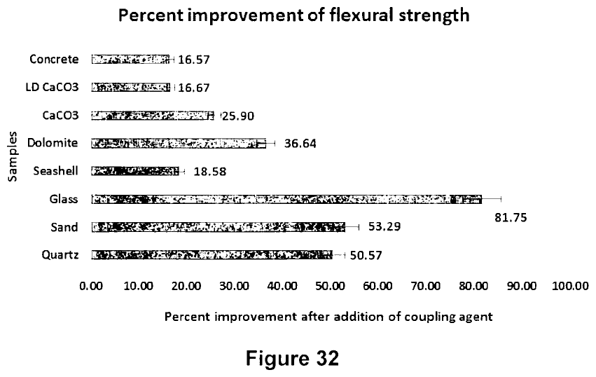

From FIG. 28 and FIG. 32, it can be seen that quartz, sand and glass, which comprise hard SiO₂ particles, have flexural strengths of 53.0, 51.2, 47.8 MPa respectively. An improvement of more than 50% is observed in both quartz and sand with the highest increase (81.75%) observed in glass composite panels. The optional coupling agent enhances the surface adhesion between resin and powder, reducing the weak spots in the panel and allowing cracks to extend through the resin matrix and bridge through the powder filler particles. Similarly, with the addition of the optional coupling agent, flexural strength of calcium carbonate-based composites also improves to around 35 MPa, with seashell panels increasing to an average value of 38.3 MPa due to its fibrous nature. The strength improvements in calcium carbonate slabs are seen in FIG. 32 to be in the range of 18-36%. Furthermore, it can be observed in FIG. 32 that the addition of a coupling agent only showed minor improvement in low-density CaCO₃ and concrete panels. Although surface adhesion between powder and resin might improve with a silane coupling agent, the porous structure and the clustering powder in concrete and LD CaCO₃ powder are still the weakest spots in the final composite panel.

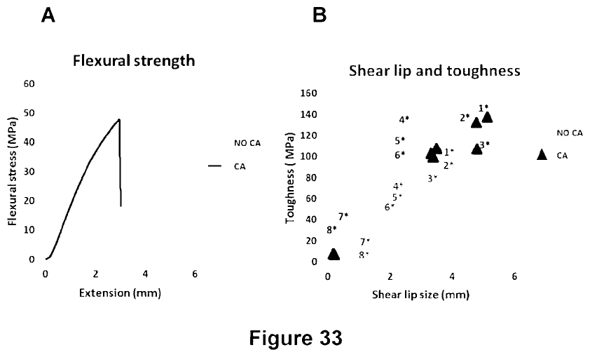

From FIG. 33A, it was observed that surface treatment using silane coupling agent improved not only the flexural strength but also the modulus of elasticity and toughness.

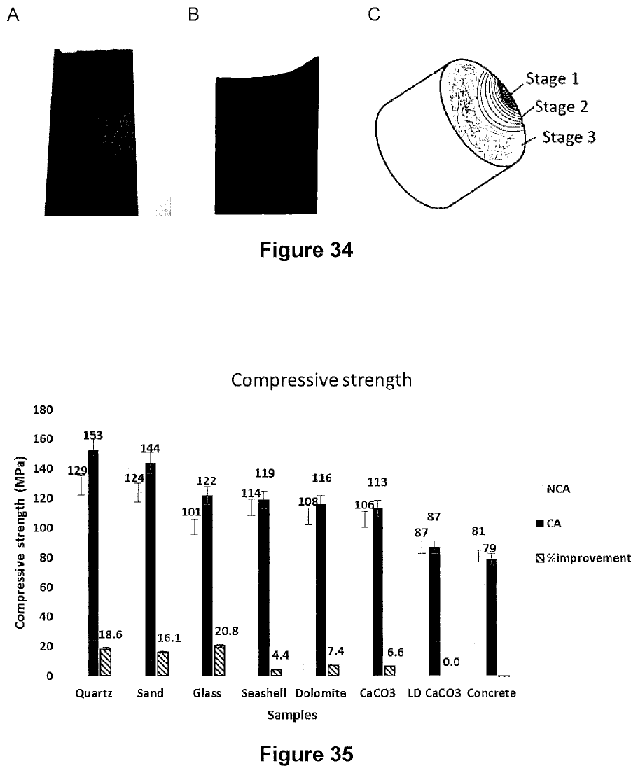

MOE, also known as the flexural modulus is a mechanical property that measures the composite's stiffness. The higher the value is, the better the composite's resistance to elastic deformation under load or the stiffer the material. Low MOE materials are flexible and tend to deflect considerably under load. From FIG. 33A, it was observed that MOE/stiffness increases with the addition of a coupling agent, with an increase in PGC from 5 to 20 MPa. The long hydrophobic polymer chain of silane coupling agent at the interface of resin and powder filler provides better stress transfer among these components, resulting in higher stiffness and strength. Toughness is the ability of a material to absorb energy and plastically deform without fracturing. The toughness of the composite was measured in this example from the area under the flexural strength-strain curve. In FIG. 33B, an average improvement of 30 to 40 percent was observed in all tested samples, except for concrete and low-density CaCO₃. When a semi-ductile material is tested to failure under a bending test, the crack propagation can be divided into three stages as shown in FIG. 34C:
Stage 1 (Short crack growth propagation stage)
Stage 2 (long cracks)
Stage 3 (Catastrophic failure)

During stage 1, the fracture will exhibit a 45-degree lip. The 45-degree lip is where the maximum slippage has occurred between the components in the material. The crack propagates until it is caused to decelerate by a microstructural barrier such as a grain boundary, inclusions, or other factors which cannot accommodate the initial crack growth direction. When the stress intensity factor K increases as a consequence of crack growth, slips start to develop perpendicular to the load direction, initiating stage II, followed by unstable crack growth (catastrophic rupture) in stage III.

All of the composites in this study showed 45-degree lips which correspond to material failing at high shear stress. Higher toughness materials are shown in this example to have a bigger shear lip size. From FIG. 34B, an addition of around 1 mm lip size was observed in all samples after the addition of coupling agent.

### Compression Strength

FIG. 35 shows the compressive strength of the powder-resin composite. In the absence of coupling agent, panels made from quartz and sand were found to have comparable compressive strengths of 129 and 124 respectively, both of which may be useful in certain applications.

Furthermore, it can be observed that glass, dolomite and CaCO₃ have a comparable strength of approximately 100-110 MPa. Seashell was observed to have higher strength due to its rough surface and fibrous nature. On the contrary, the clustering of LD CaCO₃ powder and porous concrete particulates result in lower compressive strength.

Similar to the flexural test, with improvement in the interfacial adhesion from the coupling agent, the powder particles may work effectively in enhancing the compressive strength of the final composite panel.

### Scratch Resistance Test

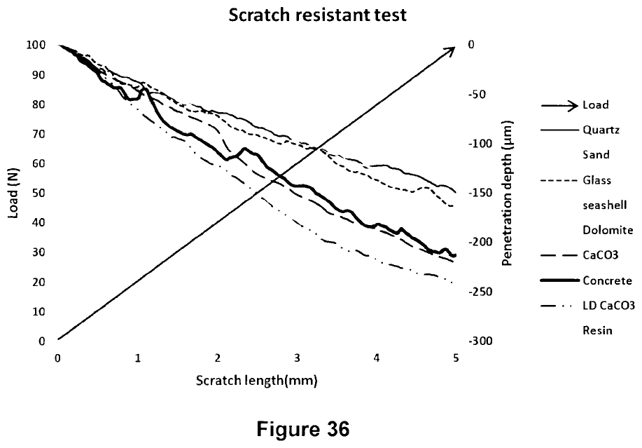

FIG. 36 illustrates the penetration depth of the tested samples at increasing load of 1-100 N within 5 mm scratch length. It was observed that the penetration depth in quartz and sand composite panels increased linearly with a load from 0-150 μm. The value was comparable to glass composite with a depth of 0-160 μm. The slightly less scratch resistance values in PGC was due to the nature of glass which has a lower hardness (Mohs hardness: 5.5) compared to quartz composite panel which mainly comprises powder of Mohs hardness 7. The high hardness of crystalline SiO₂ in quartz and sand was due to strong covalent bonds that hold the silicon and oxygen in arranged covalent structure.

Furthermore, in comparison to that of silica-based composites, it was observed that the scratch-resistance in all CaCO₃ panels was lower by around 50 μm. Calcium carbonate is made up of two ions: cation (Ca²⁺) and (CO₃²⁻). The calcium and carbonate ions are held together by ionic bonding with the carbon and oxygen atoms in carbonate ion being held together covalently. The ionic bond is the result of the electrostatic attraction between two oppositely charged ions, Ca²⁺ and CO₃²⁻. Such bonding is weaker than covalent bonding and therefore produces moderate hardness (Mohs hardness: 3) and strength.

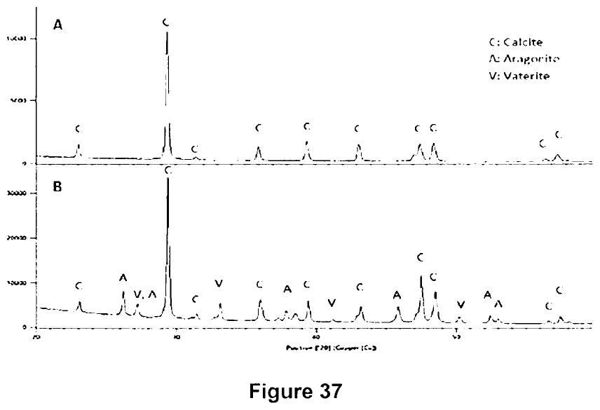

It was also observed that seashell and dolomite have better scratch resistance compared to CaCO₃ alone. Seashell, although made from CaCO₃, comprises 2 different crystal structures, with a layer of calcite on the outside of their shell while building an aragonite layer on the inside of their shell. This was shown from XRD analysis in FIG. 37. Aragonite has a structure that is more resistant to stress than calcite. This results in higher hardness compared to other calcium carbonate-based panels. In dolomite, the magnesium particles occupy one layer by themselves followed by a carbonate layer which then is followed by an exclusive calcite layer and so forth. The stable arrangement results in higher hardness compared to CaCO₃.

The penetration depth of the concrete panels was also found in this example to stand in parallel with seashells but with more fluctuation due to the mixed calcium silicate content as well as the impurities within. In addition, low-density CaCO₃ has the lowest penetration depth with a value of −240 μm at 100 N. The low value was due to the clustering powder as well as higher resin content to cover up the larger surface area of the smaller particle powder filler.

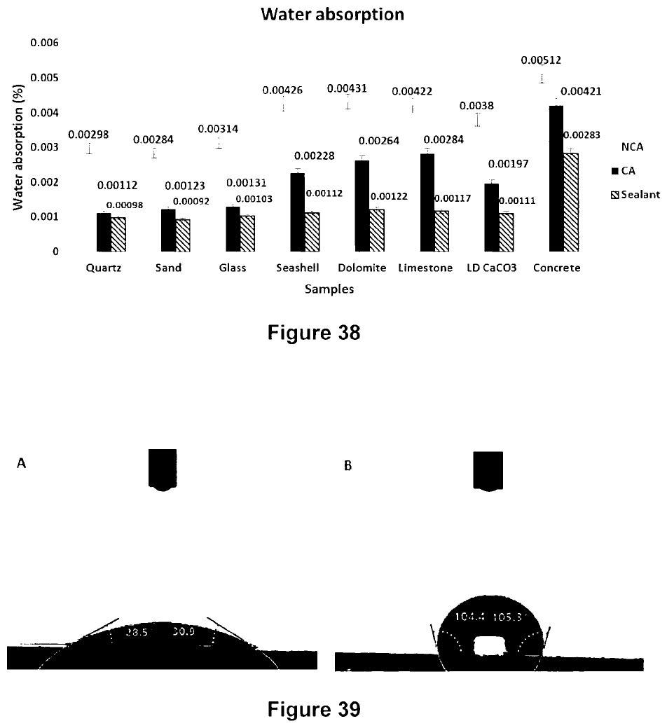

FIG. 38 summarizes the water absorption of the produced samples. It was observed that the samples without coupling agent show average water absorption ranging from 0.0284 to 0.00512%. The powder in this example is inorganic and contains hydroxyl groups (—OH) on its surface. The hydrophilic powder on the surface of the final products tends to absorb a certain amount of water. Regardless, water absorption in the final product is still less than 0.01%. This is due, at least in part, to the hydrophobicity of the resin used.

With the addition of an optional coupling agent, improvements in water-resistance are observed to increase by approximately 60-70 percent. Silane coupling agent has hydrophobic surfaces that reduce wetting on the powder surface. FIG. 39B shows an increase in the contact angle or hydrophobicity of the sample after the treatment with the average contact angle increasing from 29.7 to 104.85° when 2% of silane coupling agent is added.

Industrial sealant, e.g., silane and siloxane may be produced from a raw silane compound. When its chemical bonds are broken, silane reverts to its silicon and hydrogen bases. Silane has a relatively small molecular structure and is suitable for dense surfaces. The silane bonds with the substrate, narrowing any porous channels and making them too small for water molecules to breach. The end result is a more water-resistant surface. Similarly, siloxane is also formed with raw silane but includes oxygen in its initial silicon-hydrogen base. It has a larger molecular structure than silane, allowing to be used for waterproofing slightly more porous surfaces.

### Thermal Degradation

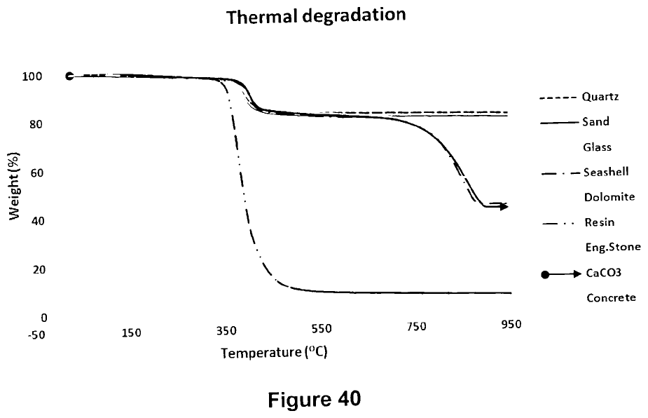

Thermal degradation was measured using thermogravimetric analysis (TGA). PGC and engineered stone comprise a polymer binder. At elevated temperatures, the components of the long chain backbone begin to break apart. It can be seen from FIG. 40 that resin-composite powder began to degrade at around 270° C. with maximum degradation occurring after 350° C. which fell at the same degradation temperature as the resin binder. Resin alone was observed to have more weight loss compared to glass-resin composite with loss of 84% and 12% respectively. This is due to the use of a smaller amount of resin in the composite panel. Regardless, the service temperature of these two materials fell in the same category.

### Comparison to Standard

Table 6 shows the mechanical properties of commercial stones in the market. Except for low-density CaCO₃ and concrete-resin panels, it was found that all the produced samples offered superior performance in flexural strength with values ranging from 27-53 MPa, compared to granite and marble with a strength of 14-28 and 6-27 respectively. When treated with CA, silica-based panels are comparable to that of commercial engineered stones. Besides strength, the breaking load of the panel is also determined by the actual dimension of the finished unit. High flexural strength composites can be produced in larger and thinner slabs, which may be used to span greater distances at a relatively light weight.

Compression strength of the composite panels in this example ranges from 81-153 and 79-129 MPa when untreated and treated with CA respectively. The compression strength measures the resistance to crushing and is rarely a problem in construction. For a comparison, a residential and commercial structure concretes have a compressive strength as low as 17 and 28 MPa respectively.

TABLE 6
Comparison to standard

| | | | | | Thermal |
|---|---|---|---|---|---|
| | Flexural | Compression | Water | Scratch | degradation |
| | strength | strength | absorption | resistance at | temperature |
| | (MPa) | (MPa) | (%) | 100N load | (° C.) |
| Granite | 14-28 | 120-131 | 0.01% | −88 | >1000 |
| | | | (Coated: | | |
| | | | 0.00123%) | | |
| Marble | 6-17 | 52-72 | 0.04% | −240 | −848 |
| | | | (Coated | | |
| | | | 0.00186%) | | |
| Engineered | 37-53 | 129-188 | 0.0014% | −162 | −350 |
| stone | | | | | |

### End of Life Panels

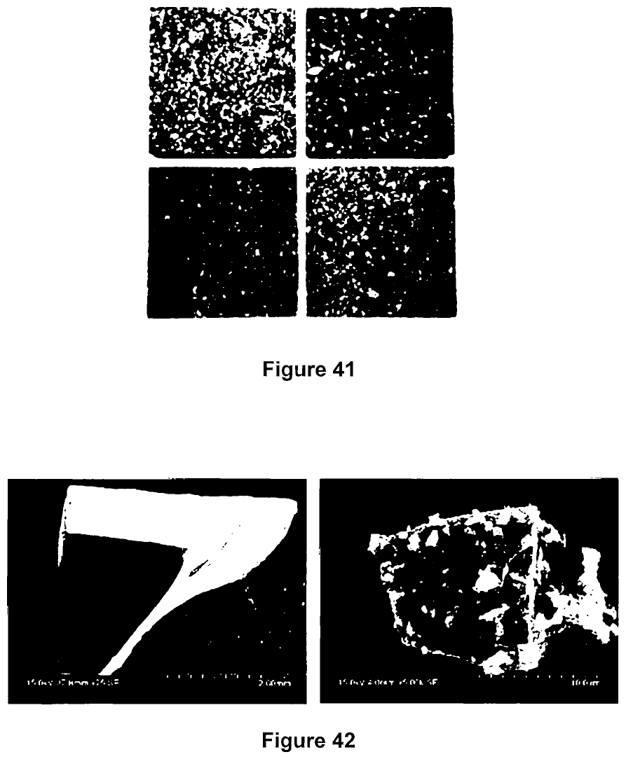

The production process of the recycled panel is similar to the powder-resin composite production explained above and is mainly comprised of 50% of 1-4 mm aggregates, 30% of fine aggregate with a size below 0.1-1 mm, 10% of fine powder (108 um) and 10% mixture of resin and hardener. The resulting panels are shown in FIG. 41 to imitate the look of granite. The mechanical properties are also reported in Table 7 below. The mechanical properties are comparable to that of produced panels in this example.

TABLE 7
Mechanical properties of recycled panels

| No. | Mechanical properties | Mechanical properties |
|---|---|---|
| 1 | Flexural strength (MPa) | 33.9 |
| 2 | Flexural Modulus (GPa) | 5.35 |
| 2 | Compression strength (MPa) | 113.5 |
| 4 | Water absorption (%) | 0.0112 |

### Example 3

### Waste Glass

TABLE 8
XRF elemental analysis of different types of glasses in weight percentage (wt %).

| Waste | | | | | | | | |
|---|---|---|---|---|---|---|---|---|
| glasses | SiO₂ | Al₂O₃ | MgO | CaO | Na₂O | Fe₂O₃ | B₂O₃ | Others |
| Mixed | 72.656% | 0.866% | 2.959% | 6.899% | 11.70% | 0.095% | 3.910% | 0.914% |
| glass | | | | | | | | |
| Blue | 66.077% | 1.717% | 1.961% | 6.686% | 21.845% | 0.162% | — | 1.552% |
| glass | | | | | | | | |
| Brown | 71.638% | 2.271% | 0.606% | 10.229% | 14.745% | 0.354% | — | 0.157% |
| glass | | | | | | | | |
| Green | 66.907% | 1.269% | 3.121% | 7.399% | 20.933% | 0.187% | — | 0.371% |
| glass | | | | | | | | |

The glasses used in this example were obtained mainly from waste window glass and bottles supplied by KGS Sydney, Australia. The clear bottle, window glasses were crushed into fine powder and mixed with resin to form the matrix of the composite panels. The colour glasses were used as decorative aggregates and sorted into five different colours—blue, brown, green, clear and mixed colour. The chemical composition of the glass was analyzed using X-ray fluorescence (XRF) analysis and is presented in table 8. The average flexural strength of glass, mainly soda lime glass, is 18 MPa with a density of 2.6-2.8 g/cm³. Other characteristics of glass are amorphous (analyzed by X-ray diffraction), low thermal expansion, zero water absorption, polar (glass contains —OH group on its surface and can be wetted by water), and glass transition temperature and a melting point of 573 and 1040° C. respectively (measured by high-temperature confocal microscope). SEM analysis also shows that glass powder and aggregate have smooth angular surfaces.

### Resin Binder

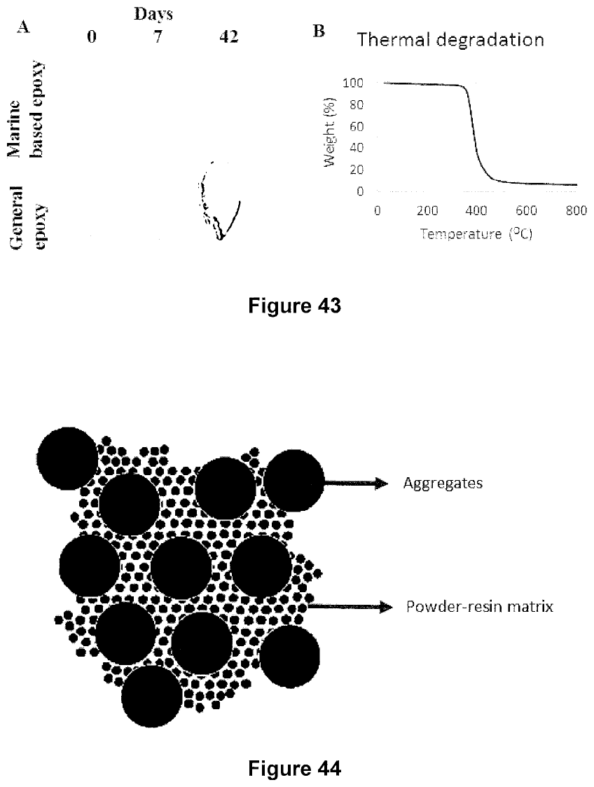

Marine-based epoxy casting resin with the commercial name, Epoxy-80 was used as the binder for the polymeric glass aggregate composite (PGAC). The resin has characteristics of medium viscosity, non-toxic, good chemical and abrasion resistance and high UV resistance. This resin is used for bar tops and flooring and has resistance to UV degradation. FIG. 43(a) compares the UV degradation of the corresponding products with general epoxy resin. The resin only showed minor coloration with its 42 days-yellowing rating being equivalent to that of 7 days-yellowing rating in general epoxy. The maximum service temperature of the resin was also analyzed by thermogravimetric analysis (TGA) to be 350° C.

### Silane Coupling Agent

Silane coupling agent (CA) with chemical formula 3-aminopropyltriethoxysilane was also used in this study. The CA was supplied from Guangzhou Double Peach Fine Chemical Co., Ltd. The CA was used to provide surface modification of non-polar materials and improve wettability with resin binder.

### Pigment

To create different appearances and designs, coloured powder from ochre stone, hematite, carbon, and titanium oxide was added. Depending on the color design, a percentage of 2 to 5% of pigment was added from the total weight of the panel. The addition of powder pigment has a negligible affect on the final mechanical performance of the panel. However, all the panels tested in this study were not-pigmented.

### Composite System

The system used in this example replicates a gap-graded composite system in concrete where the intermediate sizes of aggregate are missing as shown in FIG. 44. Gap-graded mixes are common for exposed aggregate architectural concrete finishes and may be preferable for obtaining uniform surface appearance. Similar to the gap graded in concrete, the system in powder reinforced resin permits less resin to be used and tends to be more workable, whilst maintaining substantial strength.

### Manufacturing Process and Formulation

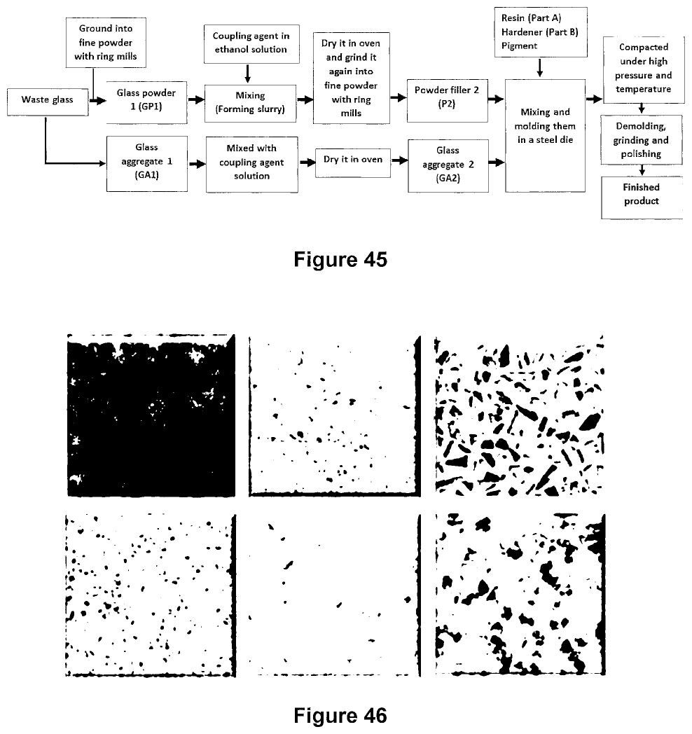

FIG. 45 illustrates the material preparation method and production steps taken to produce the polymeric glass composite panels in this example. The raw materials were subjected to an eight step process. The process comprised crushing, grinding, pre-treatment of the glass powder, drying, mixing, molding, hot pressing and cooling for disassembly. Firstly, the mixed waste glass was crushed using a jaw crusher into 1-8 mm size aggregates. The waste glass cullet was then ground into fine powder using ring mills and sifted through metal screening to a size of between 64-108 μm. At this stage, the glass powder was termed glass powder 1 (GP1) in the schematic. When a silane coupling agent was used, further treatment was applied. Consequently, the glass powder 1 (GP1) was then dispersed in a solution of diluted alcohol and silane coupling agent to form a slurry. The alcohol from the slurry was evaporated in an oven overnight. After drying, the slurry formed a chunk of compacted powder. The compacted powder was then again ground using a ring mill to obtain glass powder 2 (GP2). The fine glass powder was mixed with resin to form the matrix of the composite panels.

For the decorative aggregates, waste colour glasses mainly from bottles were collected and crushed into different sizes. Similarly, the glass aggregates were treated with a coupling agent to improve its binding capability with resin. The glass powder, aggregates, resin, and hardener were mixed according to the formulation in Table 9.

TABLE 9
Panels formulation and design parameters in weight percentage (wt %).

| | | Glass | Small | Medium | Large | | |
|---|---|---|---|---|---|---|---|
| | | powder | aggregate | aggregate | aggregate | | CA |
| | | (108 μm) | (1-2 mm) | (2-4 mm) | (4-6 mm) | Resin | (Y/N) |
| Panel | Label | (wt %) | (wt %) | (wt %) | (wt %) | (wt %) | (wt %) |
| PGC (Fine) | F00 | 80 | — | — | — | 20 | N |
| PGC + CA | F0C | 80 | — | — | — | 20 | Y |
| PGC + GA (S) | FS0 | 50 | 35 | — | — | 15 | N |
| PGC + GA (S) + CA | FSC | 50 | 35 | — | — | 15 | Y |
| PGC + GA (M) | FM0 | 50 + 5% | — | 35 | — | 15 | N |
| PGC + GA (M) + CA | FMC | 50 + 5% | — | 35 | — | 15 | Y |
| PGC + GA (L) | FL0 | 50 + 12% | — | — | 35 | 15 | N |
| PGC + GA (L) + CA | FLC | 50 + 12% | — | — | 35 | 15 | Y |

Note:
Powder glass filler along with resin binder account for 100% wt. Coupling agent was added relative to powder filler and is added after everything else is measured. Symbols: XYZ
X = Fine glass powder;
Y = aggregate size (Small(S), Medium (M), Large (L), None (0));
Z = coupling addition(C), None (0)

The blend was then mixed vigorously for at least 5 minutes to ensure homogeneity. The blend was then hand-laid in a 240×240 mm carbon steel die, lined with a non-stick Teflon sheet. The mixture was flattened and sealed with a square steel lid. The sealed die was loaded into a hydraulic hot press which was pre-heated to 80° C. It was then compacted under pressure of 550 bars for 30 minutes. The sample was then cooled to room temperature for at least 30 minutes before it was removed from the steel mould. FIG. 46 shows the final look of the glass composite panels after the samples were ground and polished to expose the aggregates.

### Mechanical Testing Procedures

The composite panels were further cut and polished into slabs with sharp edges removed for mechanical testing. The panels were tested based on American Society for Testing and Materials (ASTM) standard and were designed for countertop use. The test includes bending, compression, wear and scratch resistance, water absorption and thermal degradation test. At least 5 specimens were prepared for each test with the average value reported in the results. Unlike ceramics, the percent error of the specimens was relatively low with a standard deviation of less than 5%.

### Four Point Bending Test

The flexural strength or modulus of rupture (MOR) of a material is defined as its ability to resist deformation under load. The flexural strength value in this example was measured based on International standard ASTM C880/880M using Instron 5982 universal mechanical testing machine. Load at a uniform stress rate of 4 MPa/min was applied to failure. The dimension of the specimen tested was 240×100×18 mm with a span of 180 mm.

### Compression Test

The compressive test is used to measure the maximum amount of compressive load a material can bear before fracture. The compression value in this study was measured based on International standard ASTM C170/C170-16 using Instron 5982 universal mechanical testing machine. At least 8 specimens were tested in perpendicular and parallel orientations. However, no significant difference was found in either orientation. The dimension of the specimen was 18×18×18 mm³ with a ratio of the height and diameter in an error range of 0.9:1.0 and 1.1:1.0. Load at a uniform rate of 0.5 MPa/s was applied until the specimen failed.

### Water Absorption

The samples were first weighed dry, then immersed in water for 24 hours. They were then surface dried with a damp cloth and weighed. By measuring the weight difference between the dry and wet samples, water absorption can be calculated based on the equation 1.

$$Absorption , weight \% = [ \frac{( B - A )}{A} ] \times 100 \qquad ( 1 )$$

### Where

A=weight of the dried specimen, (g) and
B=weight of the specimen after immersion, (g)

### Scratch Testing

Scratch testing in this study was conducted using Macro scratch tester. A stylus with a sharp diamond tip was moved over a specimen surface with ascending load from 0-100 N with a scratch length of 50 mm. The penetration depth also increased progressively from the 0 to 50 mm mark. The penetration depth profile of PGC produced in this example was then compared with commercial natural and engineering stone.

### Flexural Strength

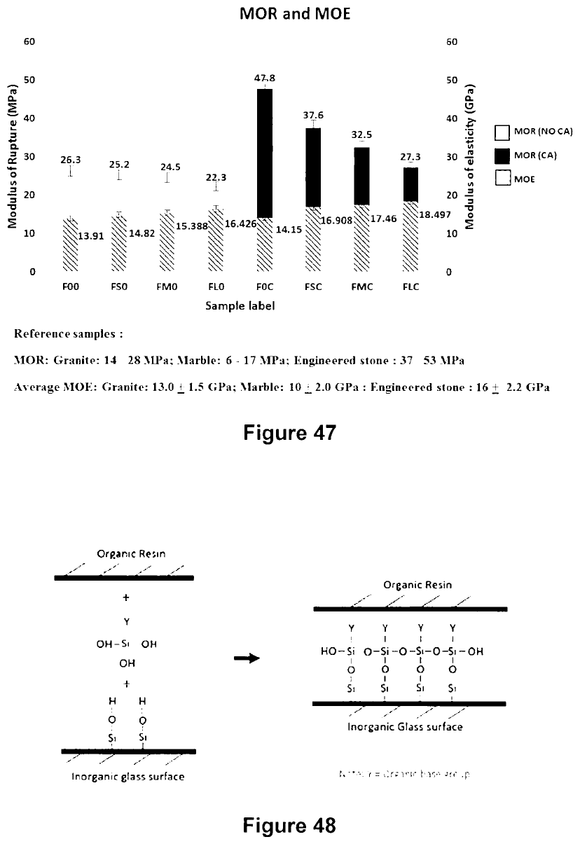

FIG. 47 shows modulus of rupture (MOR) and elasticity (MOE) of the tested panel from four-point bending test. Flexural strength (MOR) of a material is defined as its ability to resist deformation under load.

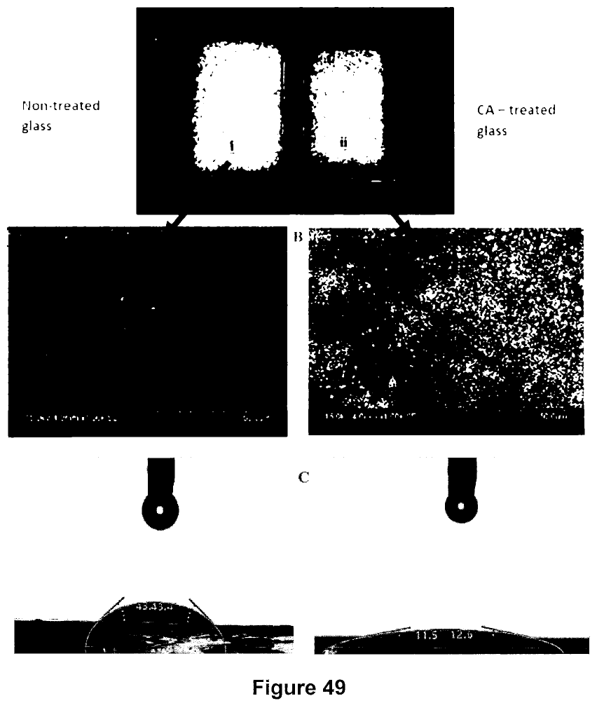

By comparing the sample groups between untreated and treated panels, an increase of 40-60% in flexural strength was observed with the addition of coupling agent. When untreated, the glass panels have an average flexural strength ranging from 22-26 MPa. Comparatively weak adhesion/wettability between the non-polar glass and polar resin is the main reason for the relatively low strength. This was shown by the high contact angle of resin on the glass substrate of 43.4° as shown in FIG. 49C. The powder and aggregates were also observed under SEM in FIG. 42 to have a smooth angular surface. An increase in strength may be desired in certain circumstances and may be achieved by firstly improving the interfacial adhesion by using coupling agent. Silane coupling agent acts as a bridge between glass and resin with the reactive groups binding to the surface of the inorganic materials and other being copolymerized with the polymer matrix. The schematic of the interfacial adhesion is shown in FIG. 48.

FIGS. 49A and B show the glass aggregate before and after the silane treatment. A white layer of hydrated silane was observed to disperse on the glass substrate after the surface treatment. Wetting was also more pronounced. A contact angle of resin on glass substrate decreased from 43.4° to 12.05° as shown in FIG. 49C. The increase in wettability corresponds to the increase in the interfacial adhesion and thus the mechanical properties. An improvement of more than 50% in flexural strength was observed in all treated glass panels with an average flexural strength of 46.8 MPa in PGC and 30-35 in PGAC.

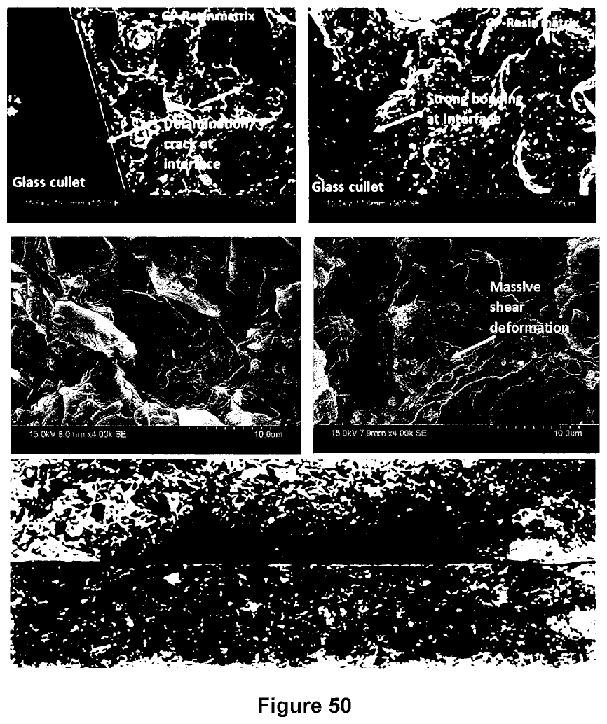

The interfacial improvement between glass and resin was also shown by fracture surface analysis which was performed by post mechanical testing of the samples. In FIG. 50A(i), it was observed that a rough surface with several pores and air gaps occurred at the fracture surface matrix when no coupling agent was added. The rough surface, which was due to particle pull-out, implied that the bonding between the powder filler and resin was relatively weak (delamination) although still useful for certain applications. Several cracks at the interface can also be clearly observed. In contrast, in FIG. 50A(ii), the fracture surface of the glass composite panel with coupling agent show shear deformation. The interface between matrix and glass aggregate becomes much stronger. As shown in FIG. 50C(ii), under load, cracks extended through the matrix, however, instead of cracks bridging between the coarse aggregate particles, cracks propagate through the glass aggregate particulates. The resulting fracture is, therefore, smoother and encourages shear yielding of the glass beads and resin matrix before failure. This failure mechanism results in the improved flexural strength of the final composite panels.

Besides coupling agents, particle size also plays a role in determining the flexural strength of the composite panels. It can be seen from FIG. 47 that for both untreated and treated samples, strength increases with decreasing glass aggregate size. The improvement was due to better dispersion of the smaller components in the composite, allowing greater interaction among the glass filler with the resin binder and minimizing the failure of higher surface contact between glass and glass particles.

With the glass surface treatment, the strength was observed to increase from an average value of 35 to 46.8 MPa. Besides the fine powder composite, all the aggregate composite panels have a strength lower than 40 MPa, which may still be useful for certain applications. The panels were found to be largely affected by the low flexural strength of glass aggregates. This was shown by the SEM analysis in FIG. 50C(ii) in which cracks propagate through the matrix and the body of the aggregates. The strength values of the aggregate composite panels were slightly higher than that of soda lime glass with an average strength of 18 MPa. Glass characteristics, as well as the powder-resin matrixes, play a role in the overall strength of the composite panels.

### Modulus of Elasticity (MOE)

MOE, also known as the flexural modulus is a mechanical property that measures the composite's stiffness. Low MOE materials are flexible and tend to deflect considerably under load. To withstand deflection, composites that are placed in a beam system preferably have a high MOE. When compared to well-graded glass—resin matrix, panel with aggregates provides lower deflection. The MOE of the panel was also found to increase with aggregate size. The coarser the grading of the glass, the lower the proportion of resin content relative to total weight required for a given workability. As shown for Table 8, the resin required for FOO, FSO, FMO and FLO to achieve the targeted viscosity are 20, 15, 14.3 and 13.4 respectively. The stiffer glass aggregate replaces certain amounts of bendable resin which results in higher MOE.

Besides aggregate size, silane coupling agent also increased the MOE of all the tested samples. As shown in FIG. 48, the silane functional group forms a covalent bond, replacing the weak hydroxyl group on the glass surface. The directional nature of covalent bonds resists the shearing motion associated with plastic flow but they are broken when shear occurs (brittle properties). The brittleness of the covalent bond by the silane CA increases the stiffness of the composite panel.

### Comparison to Standard

By comparing the samples with natural stones, it was found that both PGC and PGACs offered superior performance in flexural strength with values ranging from 27.3-47.8 MPa, compared to granite and marble with a strength of only 14-28 and 6-27 respectively. For the same tested samples, it was also found that the composite panels produced in this example have a lower standard deviation compared to the natural stones. The semi-ductile properties of the glass-resin composite panels prevent a catastrophic failure that often happens in brittle materials. The PGAC's strength, however, was slightly lower compared to most of the engineered stone sold commercially.

Besides strength, the breaking load of the panel may also be influenced by the actual dimension of the finished unit. High flexural strength composites can be produced in larger and thinner slabs, which can be used to span greater distances with relatively low weights.

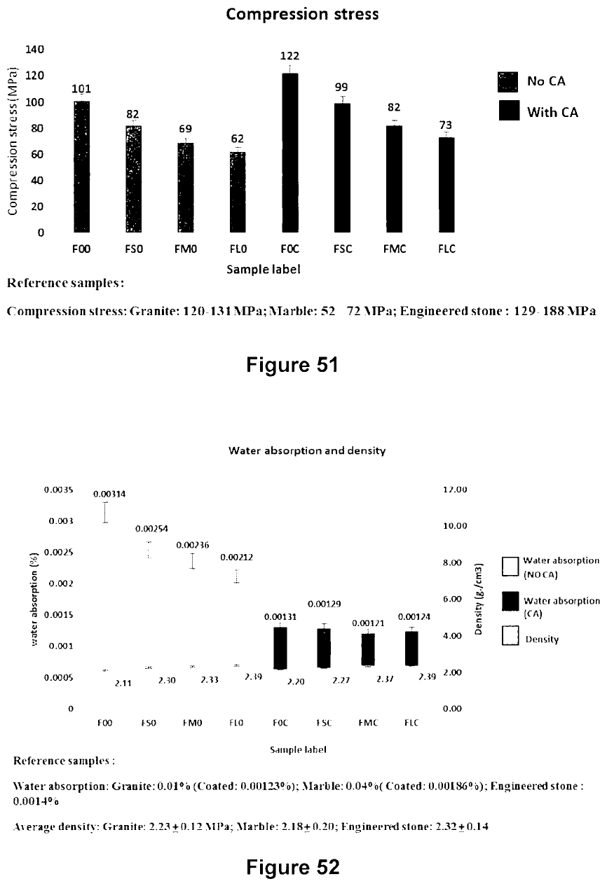

FIG. 51 shows the compressive strength of the glass-resin composite. It can be seen that for both untreated and treated samples, strength decreases with increasing glass aggregate size. FOO has the highest compression strength of 101 MPa, followed by FSO, FMO and FLO with average compression strength descending from 82, 69 and 62 MPa respectively. Similar to that of flexural strength, the tendency for cracks to occur in larger aggregates, as well as lower particle-resin interaction and higher continual interfacial region might be the cause of the reduction of strength in large aggregate panels.

In the presence of coupling agent, an increase of approximately 20% in the compressive strength was observed in all tested samples. The increase was due to the established bonding capacity between the resin and glass which was observed from SEM analysis in FIG. 50(ii).

In comparison to the reference samples, the compressive strength of PGC and PGAC was lower with values ranging from 73-122 MPa. The compression strength measures the resistance to crushing and is rarely a problem in construction. For comparison, a residential and commercial structure concretes have a compressive strength of 17 and 28 MPa respectively, with high-quality concrete for certain application reaching only up to 70-80 MPa (National Ready Mixed Concrete Association, 2003).

### Water Absorption Test

FIG. 52 summarizes the water absorption and density of the produced panels. Panels that absorb a high amount of water may be more susceptible to fungal growth, and stain, especially when the panels are used as a kitchen countertop or as shower wall panels. It was observed from this example that water absorption of the composite panels decreased with increasing aggregate particle size. When untreated with a coupling agent, well-graded powder-resin composite panel (F00) has the least resistance to moisture. This might be due to the higher surface area of the glass powder on the surface of the panels. The glass aggregate and powder contain hydroxyl groups (—OH) on their surface. The hydrophilic surface of glass tends to be wetted by water. This is more pronounced when the glass is in the form of powder due to the higher surface area. Regardless, water absorption in the final product is still less than 0.01%.

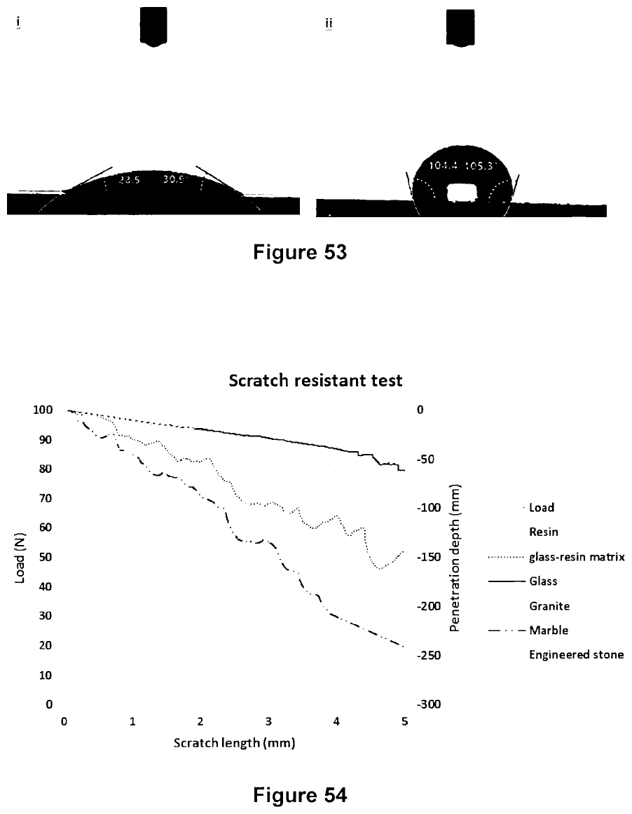

In the presence of an optional coupling agent, increases in water resistance of all samples are observed to increase to an average value of 0.00126. No significant difference in water absorption among samples is observed after the treatment. Silane coupling agent has hydrophobic surfaces that reduce wetting on both of the glass powder and aggregate surfaces. FIG. 53 shows an increase in the contact angle or hydrophobicity of glass substrate after treatment. The average contact angle increased from 29.7 to 104.85° when 2% of silane coupling agent was added. The improved water-resistant data in this study due to the addition of CA were recorded on unpolished products. After the samples were ground and polished, the water-resistant properties decrease slightly due to the exposed cross-section of the powder.

In comparison with the reference samples, it can be seen that the produced samples offer a minimal water absorption with average value ranging from 0.00121-0.00131%. The water absorption is equivalent to coated marble or granite as well as engineered stone.

FIG. 52 also reports the density of the samples and they are affected by the resin and glass content in the samples. Glass and resin have a density of 1.82 and 2.4-2.6 g/cm³ respectively. From FIG. 52, it can be observed that well-graded powder-resin composite panels have the least density of 2.11 and 2.20 g/cm³ compared to other panels with density above 2.33 g/cm³ which is due to higher resin content. Negligible differences are found among panels with a coupling agent and varying aggregate size.

FIG. 54 illustrates the penetration depth of the samples at increasing load of 1-100 N with a 5 mm scratch length. It was observed that the penetration depth in the glass-resin matrix/PGC increased linearly with a load from 0-160 μm. The scratch resistance value of the powder-resin matrix lies between the glass and resin. This value was comparable with engineering stone with a depth of 0-150 μm. The slightly less scratch resistant values in PGC may be due to the nature of glass which has a lower hardness (Mohs hardness: 5.5) compared to engineering stone which mainly comprises quartz powder (Mohs hardness: 7). The composite also showed a higher scratch resistance value than marble which comprises CaCO₃ (Mohs hardness: 3). Quartz and granite had a penetration trend line of −15 μm/cm and −12 μm/cm respectively. This was due to the harder crystalline SiO₂ fillers. Regardless of the loading rate, some impurities in granite, however, resulted in deeper scratch depth.

1. A method of manufacturing a composite product comprising:
providing particles of unseparated waste material including at least a binding portion of a polymer waste material;
mixing the waste material to provide a quantity of waste material with an approximately consistent composition across the material; and
applying heat and pressure to the quantity of waste material to form the composite product.

2. The method of claim 1, wherein at least one of:
at least a portion of the polymer waste material is polypropylene;
the unseparated waste material includes wood waste; or
the unseparated waste material includes glass waste.

3. The method of claim 2, wherein the binding portion of polymer waste material comprises at least about 30% w/w of the quantity of waste material.

4. (canceled)

5. The method of claim 2, wherein the wood waste comprises at least about 50% w/w of the quantity of waste material.

6. (canceled)

7. The method of claim 2, wherein the glass waste comprises at least about 50% w/w of the quantity of waste material.

8. The method of claim 1, wherein the composite product is a panel.

9. A composite product manufactured by the method of claim 1.

10. A composite product comprising unseparated waste material that includes a binding polymer and glass.

11. The composite product of claim 10, wherein the binding polymer comprises at least about 30% w/w of the unseparated waste material.

12. The composite product of claim 10, wherein at least a portion of the binding polymer is polypropylene.

13. The composite product of claim 10, wherein the glass comprises at least about 50% w/w of the unseparated waste material.

14. The composite product of claim 10, wherein the composite product further comprises a coupling agent.

15. The composite product of claim 10, wherein the composite product is a panel.

16. The composite product of claim 9, wherein at least one of:
at least a portion of the polymer waste material is polypropylene;
the unseparated waste material includes wood waste; or
the unseparated waste material includes glass waste.

17. The composite product of claim 16, wherein the binding portion of polymer waste material comprises at least about 30% w/w of the quantity of waste material.

18. The composite product of claim 16, wherein the wood waste comprises at least about 50% w/w of the quantity of waste material.

19. The composite product of claim 16, wherein the glass waste comprises at least about 50% w/w of the quantity of waste material.

20. The composite product of claim 9, wherein the composite product is a panel.
